(19) United States
(12) Patent Application Publication
(10) Pub. No.: US 2025/0147054 A1
(43) Pub. Date: May 8, 2025

(54) SURFACE DETECTION CALIBRATION SYSTEM AND METHOD

(71) Applicant: Opentrons LabWorks Inc., Long Island City, NY (US)

(72) Inventors: Christopher Yarka, Brooklyn, NY (US); Andres Guillermo Calderon, Woodside, NY (US); Joseph Patrick Crabtree, Collingswood, NJ (US); Seth Louis Foster, Brooklyn, NY (US); Shawn Michael Koop, Cottage Grove, MN (US); Brayan Steven Almonte-Reyes, Irvington, NJ (US); Nicholas Pease Starno, New York, NY (US)

(73) Assignee: Opentrons LabWorks Inc., Long Island City, NY (US)

(21) Appl. No.: 19/018,928

(22) Filed: Jan. 13, 2025

Related U.S. Application Data
(63) Continuation of application No. PCT/US2024/030051, filed on May 17, 2024.
(60) Provisional application No. 63/503,449, filed on May 19, 2023.

(51) Int. Cl. G01N 35/00; G01N 35/10

(52) U.S. Cl. CPC G01N 35/00693; G01N 35/0099; G01N 35/10

(57) ABSTRACT

Calibration of components of a liquid handling system are provided. As the accuracy of the components of the liquid handling system enable operations of such components, each of a moveable stage and associated attachments (e.g., pipette) and a material handling gripper system are calibrated from time-to-time. In the case of the moveable stage and associated attachments, an affixed calibration probe may be used to locate a particular spatial location at a calibration target slot. In the case of the material handling gripper system, an affixed calibration pin similarly may be used to locate a particular spatial location at a calibration target slot. Based on the movements of the moveable stage and associated attachments and the material handling gripper system to move to and find the particular spatial location, each of these systems may be calibrated.

### CROSS-REFERENCE TO RELATED APPLICATIONS

This application claims priority to PCT international No. PCT/US2024/030051, filed May 17, 2024, titled “SURFACE DETECTION CALIBRATION SYSTEM AND METHOD,” which claims priority to U.S. Provisional Application No. 63/503,449, filed May 19, 2023, titled “AUTOMATED LIQUID HANDLING SYSTEMS, TOOLS, AND CALIBRATIONS,” which are hereby incorporated by reference in their entirety.

### TECHNICAL FIELD

The present disclosure relates generally to liquid handling systems. More particularly, the present disclosure relates to calibration of components of a liquid handling system such as moveable stage and pipette combinations and a material handling gripper system.

### BACKGROUND

A liquid handling system may include a number of moveable components for distributing liquids or other materials to containers (e.g., test tubes) or devices (e.g., testing devices) and for transporting containers and devices for use by the liquid handling system. For example, robotic elements and a number of selectively couplable pipettes may be coupled to a moveable stage. The moveable stage assists in moving and precisely placing the pipettes above receptacles such as reaction containers or devices used to react liquid solutions dispensed by the pipettes. In one example, the pipettes, receptacles, and/or devices used to react the liquid solutions may be located within an enclosed space in which the reaction may be isolated from any outside environment in order to ensure that no other objects may interrupt the processes of the liquid handling system and/or the reactions taking place within the enclosed space. For another example, a liquid handling system may also include a material handling gripper system having a pair of gripper arms for carrying reaction containers or devices to various locations in the enclosed space where liquids or other types of materials may be placed for receiving one or more operations. For example, the gripper system may be used for moving a set of test tubes or other similar containers to a location in the enclosed space where one or more reactants will be added to the example test tubes or other containers.

Because such systems may include a number of moveable parts or may be made with varying tolerance levels between parts, ensuring accuracy of movement of such systems to particular locations in the liquid handling system is necessary. Thus, in order for the moveable stage with associated devices (e.g., pipettes) or the moveable gripper arms to accurately deploy liquids or other reactants or materials to containers or devices or to move reaction containers, devices to and from particular locations, the moveable stage along with associated attachments and the material handling gripper system may be calibrated from time-to-time.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a liquid handling system according to an example of the principles described herein.

FIG. 2 illustrates a perspective view of a liquid handling system deck assembly according to an example of the principles described herein.

FIG. 3 illustrates a perspective view of a moveable stage assembly including a first pipette and a second pipette, according to an example of the principles described herein.

FIG. 4 illustrates a calibration system including a pipette, a calibration probe and calibration adapter and one or more other calibration sites, according to an example of the principles described herein.

FIG. 5 illustrates a partially open view of the first pipette of FIG. 3 showing internal components of the first pipette and showing attachment of a calibration probe to a nozzle of the first pipette, according to an example of the principles described herein.

FIG. 6 illustrates a closed view and an open view of a calibration probe, according to an example of the principles described herein.

FIG. 7 illustrates a perspective view of partial internal components of the calibration probe of FIG. 6, according to an example of the principles described herein.

FIG. 8 illustrates a partial perspective view of an upper portion of a calibration probe and partial perspective view of a pipette nozzle configured for insertion into a calibration probe collet, according to an example of the principles described herein.

FIG. 9 illustrates a calibration target area to which a calibration probe or a gripper arm pin is directed for calibrating components of the liquid handling system, according to examples of the principles described herein.

FIG. 10 illustrates a pair of material handling system gripper arms with gripper jaws and illustrates a calibration pin for calibrating components of a material handling gripper system, according to an example of the principles described herein.

FIG. 11 illustrates an open view of one of the calibration gripper arms of FIG. 10 showing partial internal components of the illustrated gripper arms and calibration pin, according to an example of the principles described herein.

FIG. 12 illustrates the material handling gripper arms with gripper jaws of FIG. 11 and illustrates deployment of the calibration pin for calibrating the material handling gripper system, according to an example of the principles described herein.

FIG. 13 illustrates a flow diagram of an example method for calibrating components of the liquid handling system, according to an example of the principles described herein.

FIG. 14 illustrates a computing system diagram illustrating a configuration for a liquid handling system that can be utilized to implement aspects of the principles described herein.

### DESCRIPTION OF EXAMPLE EMBODIMENTS

### Overview

This disclosure describes methods and systems for calibrating components of a liquid handling system. According to examples, a liquid handling system may include a moveable stage for carrying one or more liquid handling devices or systems. Devices or systems that may be carried by the moveable stage include one or more pipettes and associated devices (e.g., pipette nozzles and a variety of nozzle attachments) for delivering and distributing liquids or other materials to one or more containers (e.g., test tubes, beakers, and the like). According to other examples, the liquid handling system may also include other devices or systems, including a material handling gripper system having gripper arms for transporting containers or devices to and from various locations in the liquid handling system. Because such systems are comprised of many moving parts with varying tolerances between components and owing to the need for such systems to precisely distribute liquids and to transport liquid handling containers or devices in the liquid handling system, calibration of the components of the liquid handling system may be required. That is, the accuracy of the moveable stage and attached devices such as a pipette to deliver liquids and other materials to containers or other devices at various locations in the liquid handling system is important. Likewise, the accuracy of the material handling gripper system to pick up, move, and deposit containers or devices to and from various locations in the liquid handling system is important. Thus, from time-to-time, components of the liquid handling system may be calibrated to ensure operational accuracy.

According to one example, a pipette affixed to a moveable stage may receive a calibration probe associated affixed to a pipette nozzle. The moveable stage along with the pipette and attached calibration probe may be moved to a calibration target slot positioned in a calibration adapter or positioned in one or more other deck components or locations in the liquid handling system. At the calibration target slot, the pipette with the calibration probe is lowered until the calibration probe touches the surface of the calibration adapter or other liquid handling system deck location next to the calibration target slot. Touching the surface of the calibration adapter or other liquid handling system deck location next to the calibration target slot is indicated by electrical conductivity between the calibration probe and the touched surface where both the calibration probe and the touched surface are made of electrically conductive materials. Through an in iterative process of moving the calibration probe in an up and down and lateral movement, the calibration probe may be used for detecting the geometry of the calibration target slot. According to an example, the location of sides of the calibration target slot and edges at which the calibration target slot descends below the surface of the calibration adapter or other liquid handling system deck location into the calibration target slot aperture are determined. Based on the determined geometry, the spatial position including x, y, and z coordinates of a particular location such as the geometric center of the calibration target slot may be determined and stored. The moving stage along with the attached pipette thus may be calibrated because the precise movements of the moving stage and attached pipette to move the calibration probe to the particular location (e.g., the geometric center of the calibration target slot) are now known.

According to another example, with respect to the material handling gripper system, the components of the material handling gripper system may also be calibrated. Similar to the moveable stage and pipette combination, discussed above, each of the gripper arms of the material handling gripper system may receive a calibration probe or pin at a lower end of the gripper arms. Starting with a first of the two or more gripper arms, the calibration pin is affixed to a lower end of the first gripper arm. Like the moveable stage and pipette combination, discussed above, the gripper arm with attached combination pin is lowered until the calibration pin touches the surface on the calibration adapter or other liquid handling system deck location next to the calibration target slot. As with the aforementioned calibration probe for the moving stage and pipette combination, touching the surface is indicated by electrical conductivity between the gripper arm calibration pin and the touched surface where both the gripper arm calibration pin and the touched surface are made of electrically conductive materials. Through the iterative process of moving the gripper arm calibration pin in an up and down and laterally, as discussed above for the moving stage and pipette combination, a spatial position including x, y and z coordinates of a particular location in the calibration target slot, such as a geometric center of the calibration target slot, may be determined and stored. This process is then repeated for the second or other of the gripper arms by affixing the gripper arm calibration pin to the second of the two or more gripper arms and causing the second of the two or more gripper arms with the affixed gripper arm calibration pin to repeat the process of determining a particular spatial location within the calibration target slot. If the material handling gripper system has more than two gripper arms, the calibration process is repeated for any additional gripper arms. As with the moveable stage and pipette combination, because the precise movements of the gripper arms for moving the gripper arm calibration pins to the particular location are now known, the material handling gripper system may be calibrated.

Examples disclosed herein provide a pipette calibration probe, comprising a calibration probe shaft, a collet disposed at an upper end of the calibration probe shaft, a set of collet threads is disposed circumferentially around the calibration probe shaft beneath the collet, and a collet compression sleeve housing that is rotatably disposed around the calibration probe shaft. The collet compression sleeve housing has a set of receiver threads disposed circumferentially around an interior surface of the collet compression sleeve housing. The set of receiver threads are rotatably engaged with the set of collet threads to rotatably traverse an upper end of the collet compression sleeve housing upward onto the collet and to rotatably traverse the upper end of the collet compression sleeve housing downward off the collet. The collet compression sleeve housing is operative to rotatably traverse upward via engagement of the set of receiver threads with the set of collet threads to compress the collet into a closed configuration. The collet compression sleeve housing is operative to rotatably traverse downward via engagement of the set of receiver threads with the set of collet threads to decompress the collet into an open configuration.

The collet includes one or more compression slots disposed longitudinally from an upper end of the collet to a lower end of the collet. The collet is compressed into a closed configuration by compression of the one or more compression slots from an open configuration to a closed configuration, and the collet is decompressed into an open configuration by decompression of the one or more compression slots from a closed configuration to an open configuration. Compression of the one or more collet slots is caused by an upward traversal of the upper end of the collet compression sleeve housing onto the collet, and decompression of the one or more collet slots is caused by a downward traversal of the upper end of the collet compression sleeve housing off the collet.

According to examples, the collet includes an orifice in an upper end of the collet, the orifice being in longitudinal alignment with the calibration probe shaft. The orifice in the upper end of the collet is configured to receive a lower end of a pipette nozzle wherein the lower end of the pipette nozzle is in longitudinal alignment with the calibration probe shaft. The collet is affixed to the pipette nozzle when an upper end of the collet compression sleeve housing is rotatably traversed onto the collet.

The calibration probe shaft is comprised of an electrically conductive material, and the pipette nozzle is comprised of an electrically conductive material. The pipette calibration probe and the pipette nozzle are coupled by inserting the lower end of the pipette nozzle into the collet orifice. Coupling of the pipette nozzle with the pipette calibration probe provides a continuous electrical conductivity path through the pipette nozzle to and through the calibration probe shaft. Contact of a lower tip of the calibration probe shaft with a surface, at which a calibration of a pipette comprising the pipette nozzle is desired, provides electrical conductivity from the pipette through the pipette nozzle through the calibration probe shaft and to the surface. Electrical conductivity from the pipette through the pipette nozzle through the calibration probe shaft and to the surface provides for capacitive sensing of a point of contact of the lower tip of the calibration probe shaft with the surface. According to an example, providing for capacitive sensing includes providing an electromagnetic field about the lower tip of the calibration probe shaft enabling sensing of the point of contact when the lower tip of the calibration probe shaft is proximal to the surface. As used in the present specification and in the appended claims, the term “proximal” is meant to be understood broadly as one element being located adjacent to or abutting another element.

According to additional examples, a gripper arm calibration system is provided comprising a gripper arm having a calibration probe orifice disposed at a lower end of the gripper arm, a magnet disposed in an interior of the calibration probe orifice, a calibration probe or pin having a calibration probe shaft, the calibration probe shaft having an upper end and a lower end and having a retainer band disposed circumferentially around the calibration probe shaft between the upper end and the lower end. Each of the upper end and the lower end of the calibration probe shaft is configured for insertion into the calibration probe orifice until an inserted upper end or lower end of the calibration probe shaft contacts the magnet to hold the calibration probe shaft in the calibration probe orifice. The calibration probe orifice includes a pathway into the lower end of the gripper arm in longitudinal alignment with the gripper arm. The pathway has a depth corresponding to a length of the calibration probe shaft extending from the upper end or the lower end of the calibration probe shaft to the retainer band. The magnet disposed in an interior of the calibration probe orifice being further disposed at an end of the pathway configured for magnetically engaging an inserted upper end or lower end of the calibration probe shaft.

An electrical contact is disposed in an interior of the lower end of the gripper arm. The electrical contact is configured for contacting with an upper end or lower end of the calibration probe shaft when the upper end or lower end of the calibration probe shaft is inserted into the calibration probe orifice. The calibration probe shaft is comprised of an electrically conductive material, and contacting the electrical contact with the upper end or lower end of the calibration probe shaft provides a continuous electrical conductivity path from the gripper arm through the calibration probe shaft.

Contact of a lower tip of the calibration probe shaft with a surface, at which a calibration of the gripper arm is desired, provides electrical conductivity from the gripper arm through the calibration probe shaft and to the surface. Providing a continuous electrical conductivity path from the gripper arm through the calibration probe shaft and to the surface provides for capacitive sensing of a point of contact of the lower tip of the calibration probe shaft with the surface. Capacitive sensing includes providing an electromagnetic field (EMF force detection) about the lower tip of the calibration probe shaft enabling sensing of the point of contact when the lower tip of the calibration probe shaft is proximal to the surface.

According to another example, a liquid handling system calibration system is provided comprising a liquid handling system having one or more moveable components for transporting materials or devices to one or more locations on a deck of the liquid handling system. A calibration probe is affixed to a lower end of a selected moveable component of the one of the one or more moveable components for calibrating the selected moveable component. The calibration probe has electrical conductivity from the selected moveable component through the calibration probe for providing capacitive sensing of a point of contact of a lower tip of the calibration probe shaft with a surface at which a calibration of the selected moveable component is desired. The liquid handling system is operative to lower the lower tip of the calibration probe shaft to a point on the surface near an edge of a target calibration slot, the target calibration slot including a calibration aperture surrounded by a plurality of edges between the calibration aperture and a surface area around the calibration aperture. The liquid handling system is further operative to iteratively raise, lower and move the lower tip of the calibration probe until all the plurality of edges are located, to determine a geometric center or other specific point in the calibration aperture based on the located plurality of edges, and to calibrate the selected moveable component to the determined geometric center or other specific point in the calibration aperture. The selected moveable component includes at least one of a moveable stage assembly including a pipette and pipette nozzle and a gripper system arm.

Additionally, the techniques described in this disclosure may be performed as a method and/or by a system having non-transitory computer-readable media storing computer-executable instructions that, when executed by one or more processors, performs the techniques described above.

### EXAMPLE EMBODIMENTS

As discussed above, this disclosure describes methods and systems for calibrating components of a liquid handling system where the liquid handling system may include a moveable stage for carrying one or more liquid handling devices or systems, and the liquid handling system may include a material handling gripper system. As the accuracy of the components of the liquid handling system enables the operations of such components, each of the moveable stage and associated attachments (e.g., pipette) and the material handling gripper system are calibrated from time-to-time. In the case of the moveable stage and associated attachments, an affixed calibration probe may be used to locate a particular spatial location at a calibration target slot. In the case of the material handling gripper system, an affixed calibration probe or pin similarly may be used to locate a particular spatial location at a calibration target slot. Based on the movements of the moveable stage and associated attachments and the material handling gripper system to move to and find the particular spatial location, each of these systems may be calibrated.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

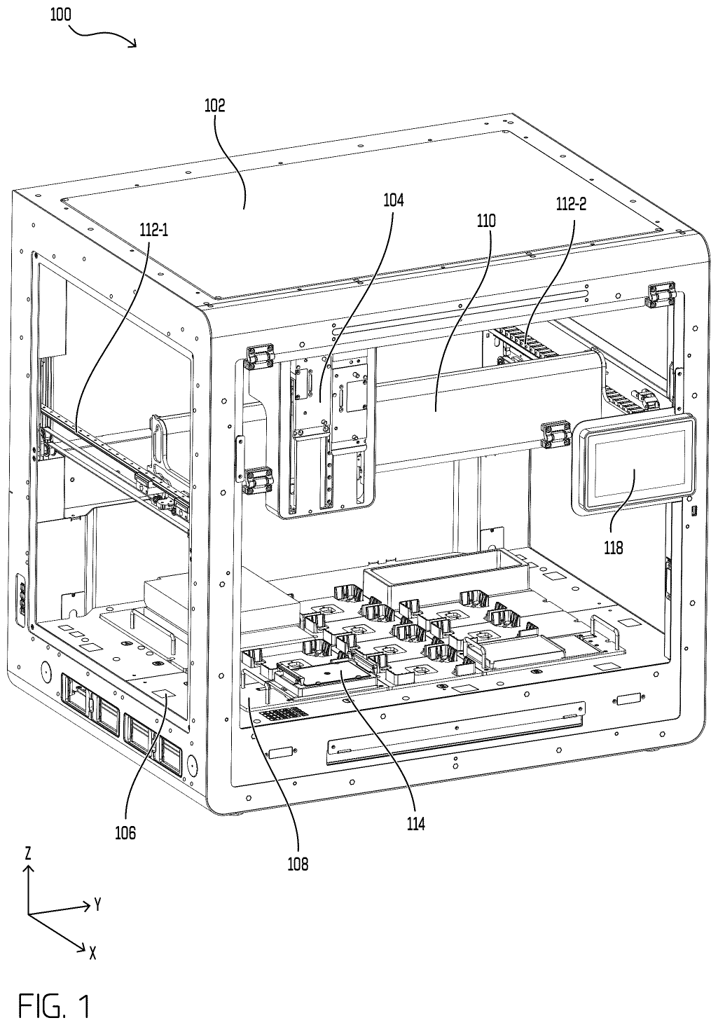

FIG. 1 illustrates a liquid handling system 100 according to an example of the principles described herein. In the examples described herein and in the appended claims, the liquid handling system 100 may also be referred to as a robot or robotic system. In one example, the liquid handling system 100 may include a housing 102. The housing 102 may include one or more sides or walls, and as depicted in FIG. 1, the housing may include a top side, four vertically positioned side walls, and a bottom side coupled to one another to form a generally box-like architecture to house and accommodate a number of liquid handling system hardware. In one example, one or more of the top side, the side walls, and the bottom side may include a transparent portion such as windows to allow for a user to view into the internal portion of the housing 102.

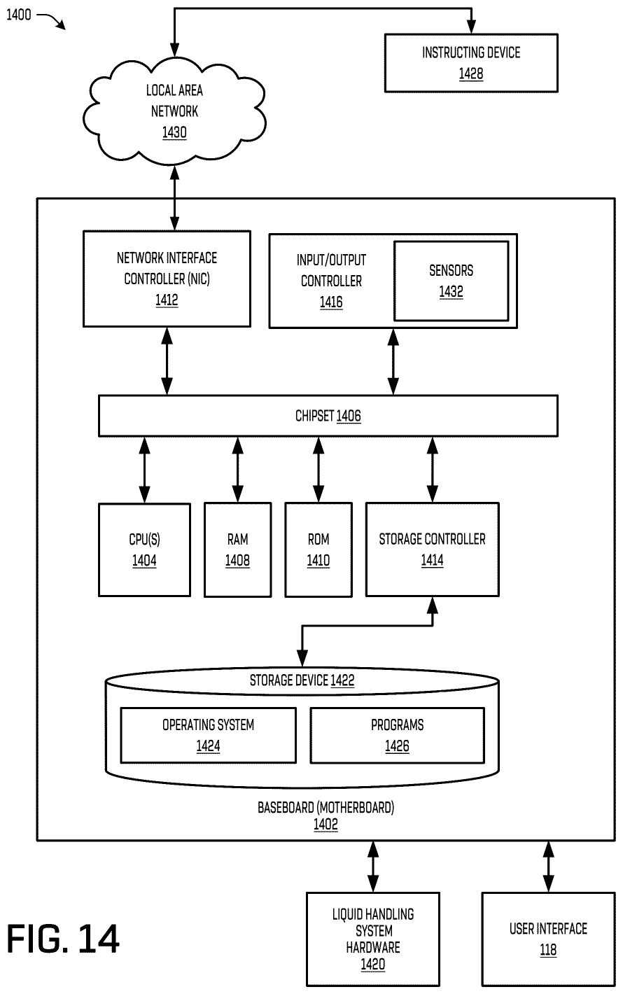

Maintained within the housing 102 may be the moveable stage 104. The moveable stage 104 may be mechanically coupled to an x-axis moveable truss 110 that may cause the moveable stage 104 to move in the x-direction. Further, the moveable stage 104 may be mechanically coupled to a first y-axis moveable truss 112-1 and a second y-axis moveable truss 112-2 that may cause the moveable stage 104 in the y-direction. The x-axis moveable truss 110 and the first y-axis moveable truss 112-1 and the second y-axis moveable truss 112-2 may be driven by one or more motors that may be actuated through instructions received from the instructing device 1428, described below with reference to FIG. 14, and any of the elements within the baseboard 1402 (FIG. 14). The instructions used to actuate the motors may cause the moveable stage 104 to be moved to a digitally addressable location within the interior of the housing 102.

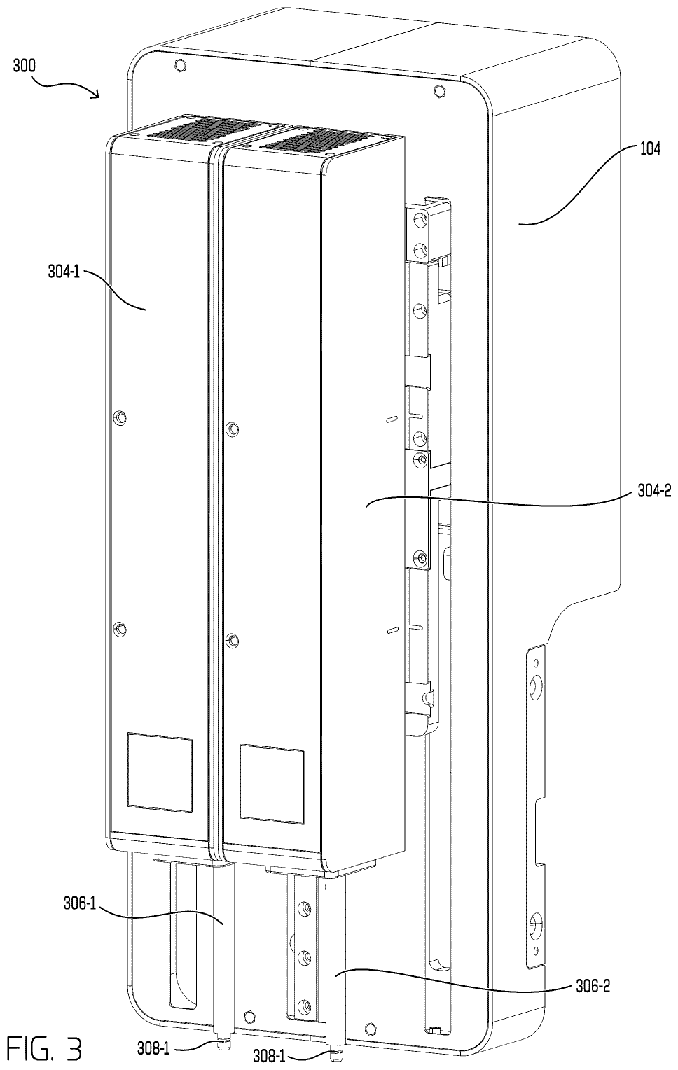

The housing 102 may further house a deck 106. The deck 106 may be located at the bottom of the housing 102 and may retain one or more cradle devices 108. The cradle devices 108 may be removably or selectively coupled to the deck 106 and may be used to retain one or more modules 114 that may be coupled to the cradle devices 108 and used to process the liquids dispensed by the liquid handling system 100. In one example, the modules 114 may include, for example, a temperature deck, a heat shaker, a thermocycler, a heating device, a cooling device, a vacuum pump, a centrifuge, a liquid handler, a tube handling device, a scaling device, an unsealing device, a magnetic device, other modules, and combinations thereof. In connection with the instructions used to actuate the motors associated with the x-axis moveable truss 110 and the first y-axis moveable truss 112-1 and the second y-axis moveable truss 112-2, these instructions may cause the moveable stage 104 to be moved to a digitally addressable location within the interior of the housing 102 including an area or portion of or a position on the modules 114 such that the pipettes, described below with reference to FIG. 3, may dispense fluids onto or into the modules 114.

As depicted in FIG. 1, the liquid handling system 100 may include the user interface (UI) 118. In one example and as depicted in FIG. 1, the UI 118 may be a touchscreen that may detect touch input from a user and includes both an input device (a touch panel) and an output device (a visual display) where the touch panel is layered on the top of the electronic visual display. The instructions and prompts described herein may be presented to the user of the liquid handling system 100 via this or another UI 118. The UI 118 may be communicatively coupled to the instructing device 1428 (FIG. 14) and/or any of the elements within the baseboard 1402 (FIG. 14). This allows the instructing device 1428 and/or any of the elements within the baseboard 1402 (FIG. 14) to present the instructions and prompts described herein via the UI 118 and to allow a user to enter information via interactive elements of the UI 118. Although depicted and described as a touchscreen, the UI 118 may include any input and output devices such as, for example, a display device, a printer, an audio speaker, a haptic device, a heads-up display, a keyboard, a mouse, a touchpad, a trackpad, an accelerometer, a gyroscope, a proximity sensor, a thermometer, a virtual reality system, an augmented reality system, a joystick, a gamepad, a paddle, a camera, a microphone, other input and/or output devices, and combinations thereof. Further, in one example, the UI 118 may not be directly coupled to the liquid handling system 100, and may, instead, be associated with a separate computing device directly or indirectly coupled to the liquid handling system 100 such as, for example, the computing system 1400 and/or the instructing device 1428 depicted and described in connection with FIG. 14.

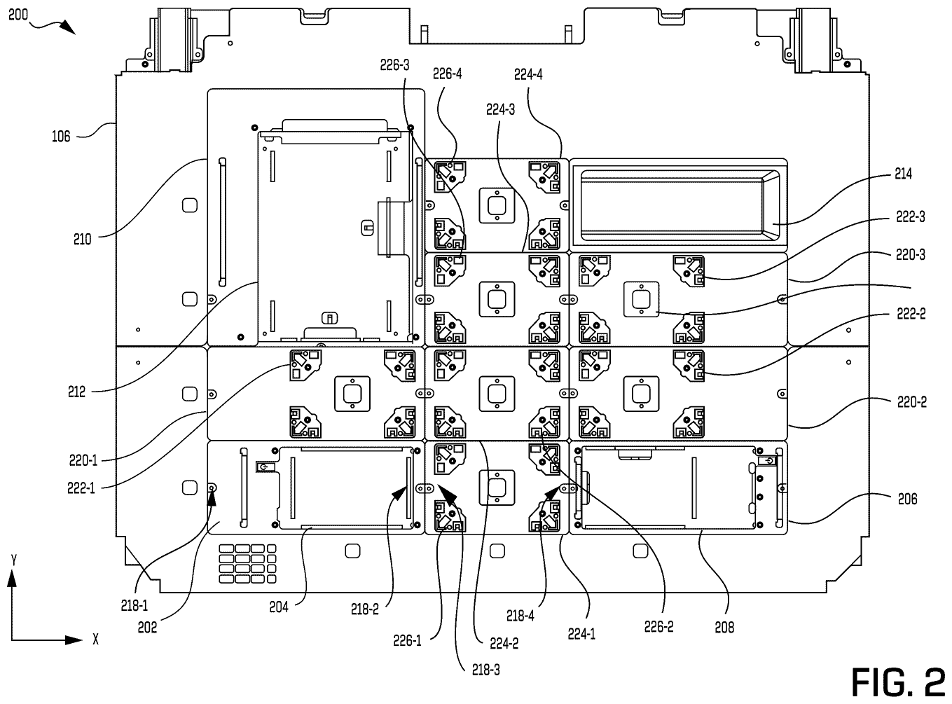

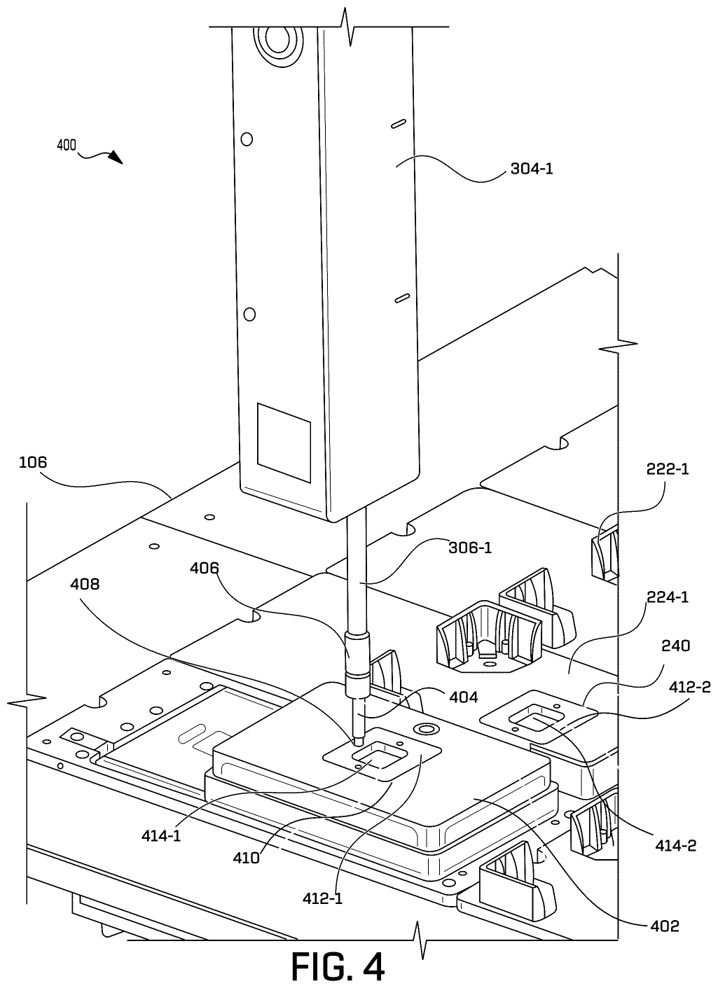

FIG. 2 illustrates a perspective view of a deck assembly 200 of the liquid handling system 100 according to an example of the principles described herein. In one example, the deck assembly 200 includes a number of different cradles devices coupled with a deck 106 and a plurality deck covers. The deck assembly 200 includes a first cradle 202, a first fluid handling module 204, a second cradle 206, a second fluid handling module 208, a third cradle 210, a third fluid handling module 212, a fourth fluid handling module 214, a first mounting aperture 218-1, a second mounting aperture 218-2, a third mounting aperture 218-3, a fourth mounting aperture 218-4, a first large deck slot cover 220-1, a second large deck slot cover 220-2, a third large deck slot cover 220-3, a first large slot cover receptacle 222-1, a second large slot cover receptacle 222-2, a third large slot cover receptacle 222-3, a first small deck slot cover 224-1, a second small deck slot cover 224-2, a third small deck slot cover 224-3, a fourth small deck slot cover 224-4, a first small cover receptacle 226-1, a second small cover receptacle 226-2, a third small cover receptacle 226-3, and a fourth small cover receptacle 226-4. In the illustrated example of FIG. 2, various cradles, are coupled with various modules, for example, a calibration adapter module coupled with a given cradle (see FIG. 4). However, while a module may be coupled to the deck 106 via a cradle, the module may also directly couple to the deck 106. For example, the module 214 is illustrated as being directly coupled with the deck 106.

In the illustrated example in FIG. 2, deck slots that are unoccupied by a cradle are covered by an appropriately sized deck slot cover. Each deck slot cover may include a deck slot cover receptacle such as the deck slot cover receptacles 222-1 through 222-3 and 226-1 through 226-3. In one example, each deck slot cover receptacle may be coupled with a laboratory equipment. In one example, a first laboratory equipment may be coupled with the first large deck slot cover receptacle 222-1, a second laboratory equipment may be coupled with the first small deck slot cover receptacle 226-1, and a third laboratory equipment may be coupled with the second large deck slot cover receptacle 222-2. The first laboratory equipment may be a test tube storage container configured to store a plurality of standard test tube, micro test tubes, or the like. Each test tube may contain laboratory materials such as, but not limited to, a biological sample, a chemical sample, a reagent, a washing fluid, a catalyst, a solute, a solvent, and/or the like. The second laboratory equipment may be a fluid handling container such as, but is not limited to, a well plate, a well reservoir, or the like. The third laboratory equipment may be a pipette tips container. In one example, a configuration of the test tubes within the first laboratory equipment, a configuration of the wells of the second laboratory equipment, and a configuration of the pipette tips within the third laboratory equipment may correspond to a configuration of pipettes being used for a lab work or the configuration of the pipettes being used for the lab work may correspond to a at least the configuration of the wells of the second laboratory equipment. For example, the second laboratory equipment may be a microplate (also referred to as a well plate) containing 96 wells with 12 wells per row along its length (e.g. along the x-axis) with 8 rows, and the configuration of the pipettes may be, but is not limited to, 12 pipettes along the length, 8 pipettes along the width (one for each row), or 96 pipettes covering all 96 wells of the well plate.

In the illustrated example, deck slot covers 220-1 through 220-3 and 222-1 through 222-3 each contain a single deck slot cover receptacle, where a size of each deck slot cover receptacle may be approximately a size of the first small deck slot cover receptacle 226-1. Alternatively, the size of the deck slot cover receptacles 222-1 through 222-3 may approximate a size of the deck slot cover receptacles 222-1 through 222-3 or the deck slot cover receptacles 222-1 through 222-3 may include two deck slot cover receptacles (e.g., a second cover receptacle may occupy an empty portion of the first large deck slot cover 220-1).

As illustrated in FIG. 2, each deck slot may include a first mounting aperture at a first longitudinal end and a second mounting aperture at a second longitudinal end opposite the first longitudinal end (e.g., the first mounting aperture 218-1, the second mounting aperture 218-2, the third mounting aperture 218-3, and the fourth mounting aperture 218-4). As a first example, the first mounting aperture 218-1 may be configured to accommodate a first header fastener and the second mounting aperture 218-2 may be configured to accommodate a second header fastener. The first header fastener may be inserted through the first mounting aperture 218-1 and removably coupled to a first mounting header and a first mounting base to secure a first end of the first cradle 202 to the deck 106. A second header fastener may be inserted through the second mounting aperture 218-2 and removably coupled to a second mounting header and a second mounting base to secure a second end of the first cradle 202 to the deck 106. Similarly, as a second example, a third header fastener may be inserted through the third mounting aperture 218-3 and removably coupled to a third mounting header and a third mounting base to secure a first end of the first small deck slot cover 224-1 to the deck 106, and a fourth header fastener may be inserted through the fourth mounting aperture 218-4 and removably coupled to a fourth mounting header and a fourth mounting based to secure a second end of the first small deck slot cover 224-1 to the deck 106.

Each of the other deck slot cover and cradles may also be secured to the deck 106 similarly as described in the examples of securing a first cradle 202 and a small deck slot cover to the deck 106. Furthermore, each mounting aperture may be a threaded aperture where the header fastener may be twisted through the threaded aperture. Additionally, or alternatively, the header fastener may include a captive screw. Alternatively, the deck slot covers and cradles may be secured to the deck 106 using clamps, magnets, or other standard mounting solutions such as snapping into place which may secure the covers and cradles to the deck 106.

FIG. 3 illustrates a perspective view of a moveable stage assembly 300 including a first pipette and a second pipette, according to an example of the principles described herein. The moveable stage assembly 300 includes a moveable stage 104 and a first pipette 304-1 and a second pipette 304-2, according to an example of the principles described herein. The first pipette 304-1 and the second pipette 304-2 depicted in FIG. 3 include a single-channel pipette form factor wherein each of the first pipette 304-1 and the second pipette 304-2 are capable of dispensing from a single pipette nozzle (e.g., a single channel pipette); namely, a first pipette nozzle 306-1 and a second pipette nozzle 306-2, respectively. In one example, the first pipette 304-1 and the second pipette 304-2 may be capable of dispensing, for example, up to 50 microliters (μL) of fluid. In one example, the first pipette 304-1 and the second pipette 304-2 may be capable of dispensing, for example, up to 1,000 μL of fluid. However, the first pipette 304-1 and the second pipette 304-2 may be designed to be capable of carrying and/or dispensing any range of volumes of fluids. Further, the first pipette 304-1 and the second pipette 304-2 may be offered and/or sold as, for example, a 20 μL pipette, a 50 μL pipette, a 200 μL pipette, a 300 μL pipette, a 1,000 μL pipette, or other types of pipette capabilities. In one example, a nozzle connection tip 308-1, 308-2 is provided for attachment of various appliances to the pipette nozzle 306-1, 306-2. For example, a fluid pipette (not shown) with a narrow lower tip may be attached to a nozzle connection tip 308-1, 308-2 for distributing a liquid from the nozzle connection tip 308-1, 308-2 into a small diameter container such as a test tube.

In one example, additional pipettes may be included in the moveable stage assembly 300. For example, a third pipette (not illustrated) may include an array of multiple pipette nozzles (e.g., an eight-channel pipette). In one example, such a third pipette may be capable of dispensing, for example, up to 50 μL of fluid. In one example, the first pipette 304-1 and the second pipette 304-2 may be capable of dispensing, for example, up to 1,000 μL of fluid. However, the third pipette may be designed to be capable of carrying and/or dispensing any range of volumes of fluid. Further, such a third pipette may be offered and/or sold as, for example, a 20 μL pipette, a 50 μL pipette, a 200 μL pipette, a 300 μL pipette, a 1,000 μL pipette, or other types of pipettes volume capabilities.

As discussed above, In one example, moveable stage assembly including the moveable stage 104 and the pipettes 304-1, 304-2 (and any other pipettes attached to the moveable stage 104 may be calibrated from time-to-time to ensure the pipette nozzle 306-1, 306-2 will accurately align over a precise location, for example, over the location where a test tube will be placed and into which a liquid from the pipette will be released. As discussed above, in order to calibrate the pipettes 304-1, 304-2 and associated pipette nozzles 306-1, 306-2, a calibration probe is attached to a nozzle connection tip 308-1, 308-2 for extending the length of the pipette nozzle 306-1, 306-2 and for conductively interfacing the pipette 304-1, 304-2 with the surface of the deck 106 at a target location. By locating a particular point at the target location, the moveable stage assembly and associated components may be calibrated for subsequent distribution of fluids or other materials at the particular point at the target location.

FIG. 4 illustrates a calibration system including a pipette, a calibration probe and calibration adapter, according to an example of the principles described herein. In one example, and as will be described in detail below, the first pipette 304-1 that is being calibrated along with other components of the moveable stage assembly 300 may be positioned to a neutral x-y position and then may be moved in the z-direction via an automated actuator towards the deck 106 until it senses the calibration probe or tip (hereafter referred to as calibration probe) 408 touches the surface of a calibration adapter or deck slot cover affixed to the deck 106. This position may be stored in a data storage device as z=0. Collision sensing may be provided via conductive interaction between the calibration probe and the surface of the calibration adapter or deck slot cover. According to an example, as described herein, collision sensing may be performed via capacitance where a capacitive charge generates a small electromagnetic field about the probe tip. When the small EMF field is pierced as the probe tip gets close to or touches the surface, the surface is sensed. Alternatively, collision sensing may be provided by motor stalling sensors that sense resistance to motion indicated by back-EMF. The motor stalling sensors may sense the force that is applied and/or when the motor stalls. In some cases, the motor drives may sense a change in capacitance and/or magnetism as the calibration tip moves towards the deck.

Referring still to FIG. 4, the first pipette 304-1 along with an attached pipette nozzle 306-1 is positioned over a calibration adapter 402 for calibrating the moveable stage assembly 300 and associated pipette and pipette nozzle to a calibration target slot 410. In one example, the calibration adapter 402 may be attached to the underlying cradle (see FIG. 2) or directly to the deck 106 at a location where one or more containers and/or devices may be used with the liquid handling system 100 as described above with reference to FIGS. 1 and 2. In one example, the shape and thickness of the calibration adapter as well as the calibration target slot 410 may be varied according to the needs of a container or other device that may be attached to the deck 106. For example, if a container that will be positioned in the upper right corner of the location where the calibration adapter 402 is illustrated, then a different calibration adapter 402 may be used that has a calibration target slot 410 positioned in the upper right corner. In addition, if a container or device that will be used at the location of the calibration adapter will be higher or lower, the thickness of the calibration adapter similarly may be modified.

Alternatively, if no calibration adapter is needed to account for varying target locations or heights of containers or devices that will receive liquids or other materials from the pipette nozzle 306-1, then the first pipette 304-1 and pipette nozzle 306-1 may be positioned over a different position, for example, the deck slot cover 224-1 of the deck 106, and the calibration target slot 240 may be used as a calibration target. That is, if it is not necessary to utilize a calibration adapter, the first pipette 304-1 and the pipette nozzle 306-1 may be positioned at any location on the deck 106 where containers or other devices may be deployed and for which calibration may be desired.

In one example, the calibration target slots 410, 240 are generally square or rectangle shaped slots that may be used for calibration in one example of the present disclosure. The calibration target slots 410, 240 may be disposed at a predetermined location on a calibration adapter 402, on a first small deck slot cover 224-1, or on the deck 106 away from locations on the deck where lab work may be taking place. In one example, the band 412-1, 412-2 (collectively referred to herein as band(s) 412) around the calibration target slot 410, 240 is co-planar with the surface of the calibration adapter 402, the deck slot cover 220 or other positions on the deck 106. The calibration slot aperture 414-1, 414-2 (collectively referred to herein as calibration slot aperture(s) 414) of each of the calibration target slots 410, 240 descends to a prescribed depth for receiving the descending calibration probe tip 408 during calibration. In one example, the calibration slot apertures 414 of the calibration target slots 410, 240 may also serve as attachment ports for attaching one or more containers, devices, etc. onto the calibration adapter 402, deck slot cover 240 or other location on the deck 106. The calibration slot apertures 414 may include any recess defined in the calibration target slot 410, 240 of the calibration adapter 402. In one example, the calibration slot aperture 414 may be centered within the band 412 of the calibration target slot 410, 240 of the calibration adapter 402. Further, although the calibration slot apertures 414 of the calibration target slots 410, 240 is depicted in the figures as a square shape or rectangular shape, the calibration slot apertures 414 may have any shape including, for example, a rounded shape, a circular shape, a polygonal shape, a cross shape, or any other shapes. In one example, the liquid handling system 100 knows the shape of the calibration slot apertures 414 in order to perform the calibration processes described herein.

Referring still to FIG. 4, in one example, in order to calibrate the moveable stage assembly and associated components, including the first pipette 304-1 and pipette nozzle 306-1, a calibration probe 406 is attached to a lower end of the pipette nozzle 306-1. As will be described further below, a calibration probe shaft 404 and calibration probe tip 408 is lowered by the first pipette 304-1 until the calibration probe tip 408 contacts the surface of the calibration adapter 402 near the calibration target slot 410. Thus, as described below, the calibration probe 406 may automatically and iteratively move in small increments until a center point or other desired point of the calibration target slot 410, 240 is located. Once the center point or other desired location of the calibration target slot 410, 240 is located, the location may be stored so that subsequent needs to move the pipette and pipette nozzle to that location will be performed accurately.

In one example, the of the calibration adapter or band 412-1 around the calibration target slots 410, 240 (deck area without a calibration adapter) may be made of conductive materials, such as metal, so that contact of the calibration probe tip 408 (also made from a conductive material) with the conductive surface allows for signaling via capacitance circuitry in the first pipette 304-1 to allow the first pipette 304-1 to know where the calibration probe tip 408 is currently located. That is, in one example, the calibration adapter 402 and the deck slot cover 240 may be electrically coupled to the deck 106. The electrical coupling may allow capacitive calibration to be used, as described herein. For example, a user may place the calibration adapter 402 onto an underlying cradle, module, or deck position for which corresponding positions require calibration of the moveable stage assembly 300. As described below, a capacitive sensing process may be used to find the positions of modules, containers, or devices to which the moveable assembly 300 and associated components (e.g., pipettes) may operate. The capacitive sensing process may be done automatically through a software application, as described below with reference to FIG. 14.

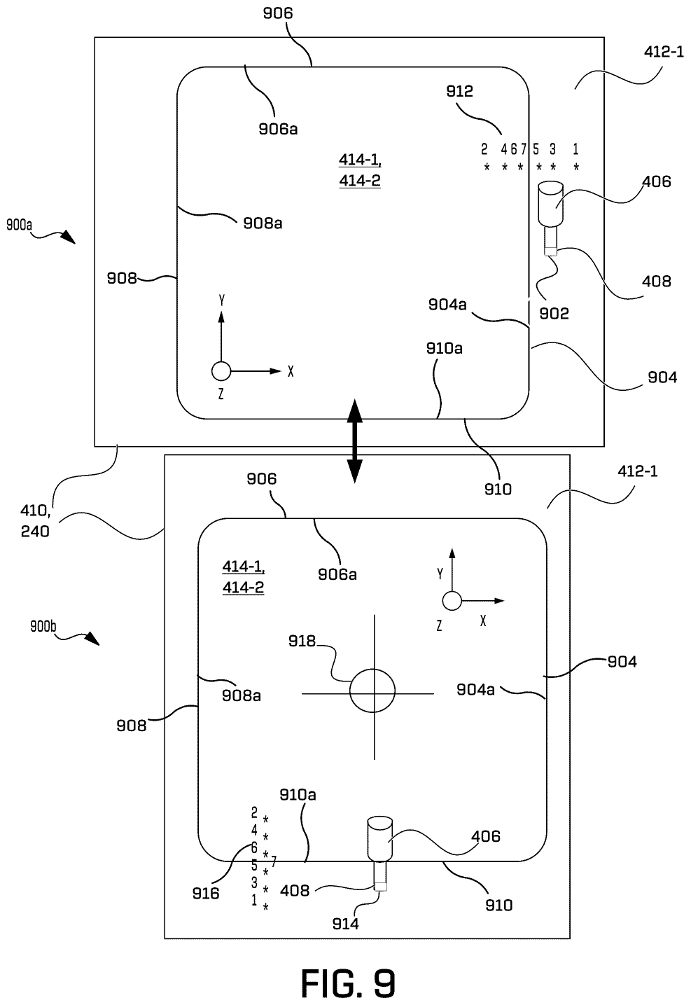

Referring still to FIG. 4, as described above, the calibration systems and methods disclosed herein may sense collisions between the calibration probe 406 and a surface of the calibration adapter 402, first small deck slot cover 224-1 or other position on the deck 106 via capacitive conductivity via capacitive sensors. Alternatively, collisions between the calibration probe 406 and a surface of the calibration adapter 402, first small deck slot cover 224-1 or other position on the deck 106 may be detected using stall detection or force feedback via back EMF sensors in the motor drive. As described further below with reference to FIG. 9, x and y coordinates may be scanned across the calibration adapter, deck slot cover or other deck location by touching the calibration probe tip 408 mimicking the pipette nozzle 306-1 at multiple points. Thus, whether the calibration probe tip 408 mimicking the pipette nozzle 306-1 hits the deck 106, hits the calibration slot aperture 414-1, 414-2, and/or hits an edge of the calibration slots, 410, 240 may be sensed. The position of the calibration probe 406 and pipette nozzle 306-1 relative to the deck 106 may be determined since the precise location and size of the square or rectangular calibration slot 410, 240 relative to the rest of the features on the deck 106 is known.

The calibration probe 406 may be a machined, metal rod that is used to avoid sterility and fragility concerns since the calibration probe 406 may touch the deck 106 during calibration. In one example, the calibration probe 406 may be designed as a single, monolithic component. Additionally, the center of the calibration probe 406 may be concentric with the center of the pipette 112. In one example, the calibration probe 406 may be secured to the pipette 112 by a collet as described herein. In other examples, the calibration probe 406 may be secured via a threaded collar, a cam latch, a magnetic force, and other securing means or methods, among others.

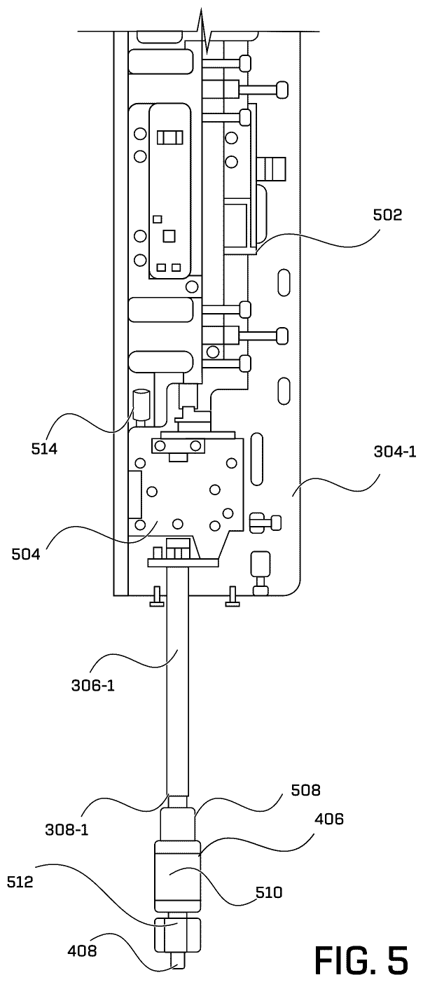

FIG. 5 illustrates a partially open view of the first pipette of FIG. 3 showing internal components of the first pipette and showing attachment of a calibration probe to a nozzle of the first pipette, according to an example of the principles described herein. As illustrated in FIG. 5, the first pipette 304-1 includes a number of internal components 502 required for operating the pipette In one example of the present disclosure including moving the pipette in various directions inside the housing 102, including moving the pipette up and down, and including distributing liquids and/or other materials through the pipette nozzle 306-1 as part of the function of the liquid handling system 100. A printed circuit board assembly (PCBA) 504 includes circuitry operative to receive and execute instructions in association with the computing system 1400 (FIG. 14) for moving the first pipette 304-1 and for distributing liquids and/or other materials, as described herein. In one example of the present disclosure, the PCBA 504 is operative to move the pipette with the attached calibration probe 406 down to the surface of the calibration adapter 402 or to the surface of the deck slot cover 240 to perform the calibration systems and methods described herein.

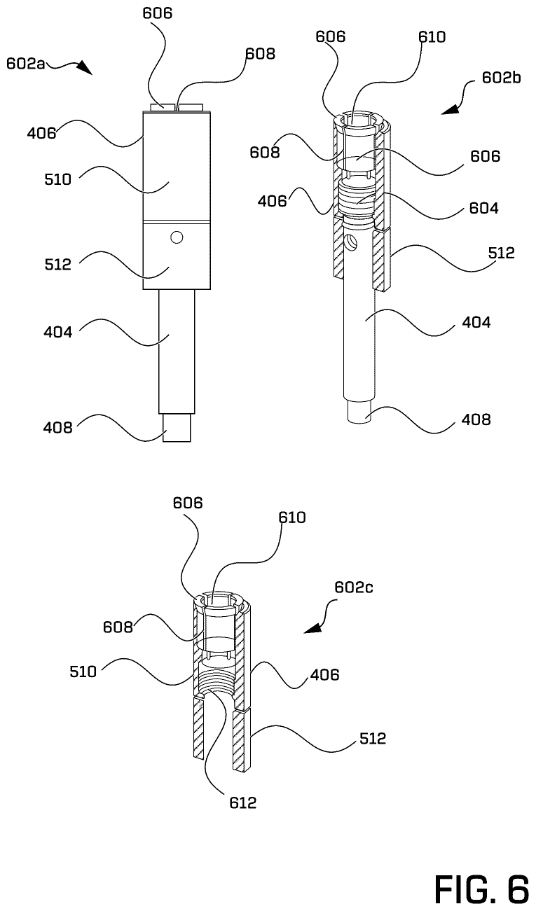

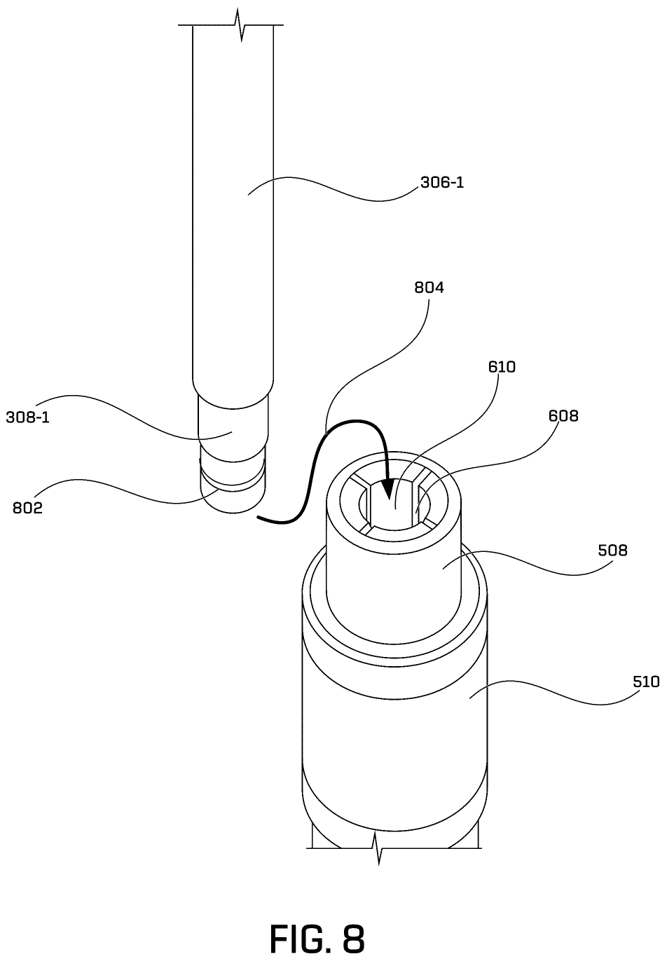

In FIG. 5, the calibration probe 406 is illustrated affixed to the nozzle connection tip 308-1 at the lower end of the pipette nozzle 306-1. The calibration probe 406, described in detail below, includes an upper collet housing 508 in which is configured a collet for tightening the calibration probe to the nozzle connection tip 308-1. The calibration probe 406 also includes a collet compression or tightening sleeve 510 for rotatably tightening the calibration probe 406 to the nozzle connection tip 308-1. An optional control handle or member 512 is provided for assisting in securing the calibration probe 406 to the nozzle connection tip 308-1. A lower calibration probe tip 408 is provided for contacting the calibration probe 406 with a surface of the calibration adapter 402, first small deck slot cover 224-1 or other location on the deck 106 for calibrating moveable stage assembly 300, including the first pipette 304-1 and pipette nozzle 306-1. In one example, the pipette nozzle 306-1 and the calibration probe (see FIGS. 6 and 8) are both constructed of a conductive material.

Referring still to FIG. 5, a capacitor 514 is provided for storing charges in an electrical circuit passing at the direction of the PCBA 504 through the pipette nozzle 306-1 and through the calibration probe 406 and through the calibration probe tip 408 when the calibration probe tip 408 contacts a conductive (e.g., metal) surface of the calibration adapter 402, the first small deck slot cover 224-1 or other location on the deck 106 in the process of finding a location in the calibration target slot 410, 240 for calibrating the moveable stage assembly 300, including the first pipette 304-1 and pipette nozzle 306-1. As understood by those skilled in the art, a capacitive collision detection system may generate a small electromagnetic field about the tip of the calibration probe 406 that may detect collision or near collision with a surface even if the surface is not made of a conductive material.

Referring now to FIGS. 6-9, components of the calibration probe 406 are illustrated and described in detail. In one example of the present disclosure, the surface-detection calibration probe 406 described herein may include machined metal or other conductive materials that may be attached to the first pipette 304-1 by hand or by machine. In examples, the calibration probe 406 may be comprised of a material such as metal, which in addition to being electrically conductive, may be used to avoid sterility and fragility concerns since the calibration probe 406 will touch the calibration adapter, deck slot cover or other deck locations during calibration. The tolerances of the metal, machined calibration probe 406 may be tighter than an injection molded tip used during liquid handling processes and may improve the accuracy of the calibration.

Referring now to FIG. 6, a closed view and an open view of a calibration probe 406 is illustrated and described. As illustrated in FIG. 6, the calibration probe 406 provides a collet 606 for affixing the calibration probe 406 to the nozzle connection tip 308-1 at the lower end of the pipette nozzle 306-1. In one example, the collet 606 is in longitudinal alignment with the calibration probe shaft 404 of the calibration probe 406. As shown in depiction 602a, the collet compression or tightening sleeve 510 covers the collet 606 and is configured for tightening the collet 606 around the nozzle connection tip 308-1 as described below. In an alternate version of the calibration probe 406 illustrated in FIG. 6, the upper collet housing 508, illustrated in FIG. 5 is not utilized. In one example, the collet compression or tightening sleeve 510, illustrated in FIG. 6, is used for tightening the collet 606 around the nozzle connection tip 308-1 and for covering the collet 606. The optional control handle or member 512 is provided for assisting in securing the calibration probe 406 to the pipette nozzle 306-1 and for providing strength to the calibration probe shaft 404. The calibration probe tip 408 provides for a contact point for touching the calibration probe 406 to the surface of the calibration adapter 402, first small deck slot cover 224-1 or other deck location during calibration as described below with reference to FIG. 9.

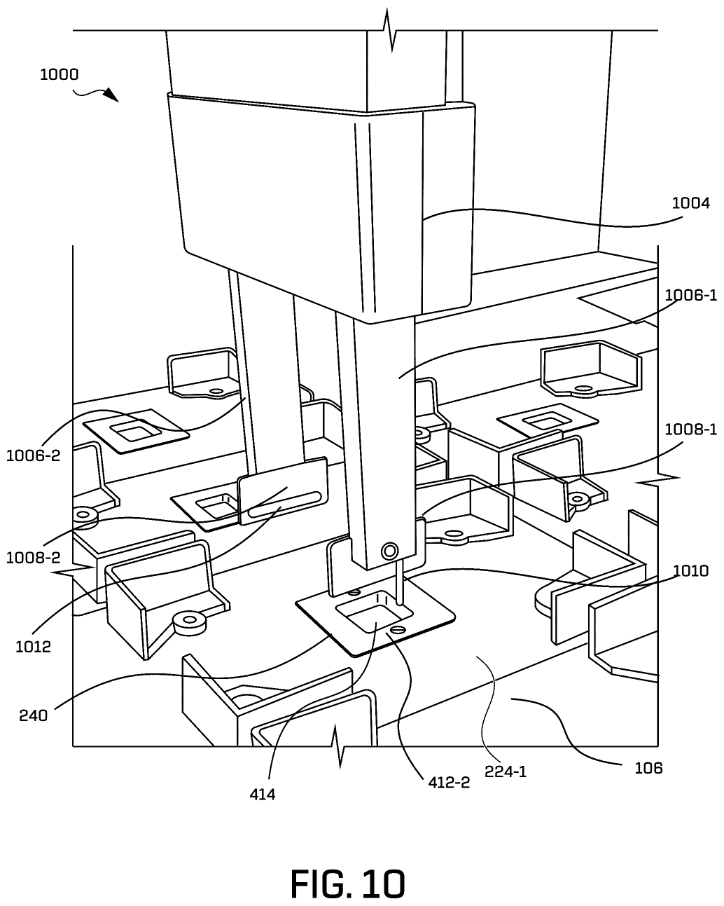

Referring to the partial cutaway depiction 602b of the calibration probe 406, at an upper end of the calibration probe shaft 404, a set of collet threads 604 are circumferentially disposed about the upper end of the calibration probe shaft 404 underneath the collet for causing a tightening of the collet 606 around the nozzle connection tip 308-1. Referring to the cutaway depiction 602c of the calibration probe 406, a set of receiver threads 612 are circumferentially disposed about an interior surface of the collet compression or tightening sleeve 510. In one example of the present disclosure, when the collet compression or tightening sleeve 510 is turned, the collet threads 604 above the upper end of the calibration probe shaft 404 are engaged with the set of receiver threads 612 in the interior of the collet compression or tightening sleeve 510. Engagement of the collet threads 604 with the receiver threads 612 of the collet compression or tightening sleeve 510 causes the tightening sleeve 510 to rotatably traverse upward. Rotatable traversal of the collet compression or tightening sleeve 510 upward causes a circumferential compression or squeezing of the collet 606 by closing gaps or slots 608 positioned around the collet 606 longitudinally from an upper end of the collet to a lower end of the collet. The circumferential compression or squeezing of the collet 606 causes compression of the collet slots and causes the collet 606 to tighten or grip the nozzle connection tip 308-1 and to secure the calibration probe 406 to the lower end of the pipette nozzle 306-1. Reversing the turning of the collet compression or tightening sleeve 510 causes the collet compression or tightening sleeve 510 to rotatably traverse downward along the calibration probe shaft 404 and decompresses the collet slots and relieves the circumferential compression or squeezing of the collet 606 to allow the calibration probe 406 to be removed from the pipette nozzle 306-1. In one example, the calibration probe 406 may be installed by a user, or alternatively, the calibration probe 406 may be installed automatically by a material handling gripper system, as described below with reference to FIGS. 10-12.

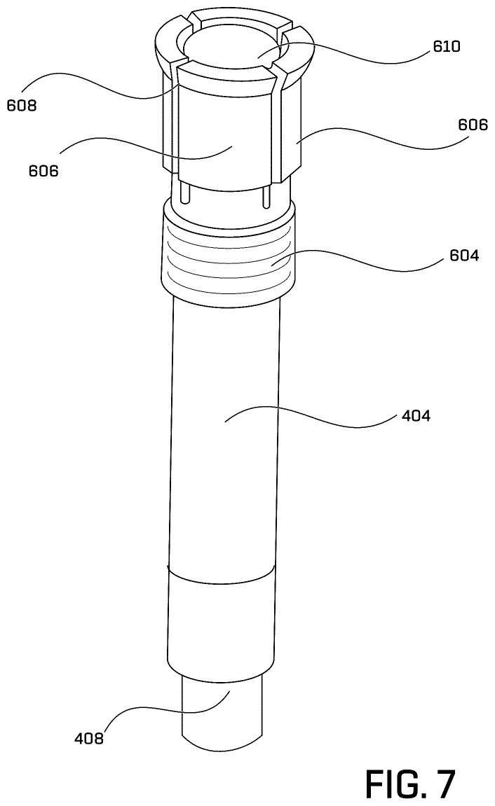

FIG. 7 illustrates a perspective view of partial internal components of the calibration probe 406 of FIG. 6, according to an example of the principles described herein. FIG. 7 shows some of the internal components of the calibration probe 406 without the collet compression or tightening sleeve 510. The collet 606, the collet threads 604, the collet probe shaft 404, and the calibration probe tip 408 may be manufactured from a single piece of conductive material or may be assembled from one or more separate components so that the combined unit is conductive. Then, when the nozzle connection tip 308-1 is inserted into the collet orifice 610, as illustrated in FIG. 8, capacitive conductivity becomes continuous from the PCBA 504 of the first pipette 304-1 through the pipette nozzle 306-1 and then through the calibration probe 406, as illustrated in FIG. 5.

FIG. 8 illustrates a perspective view of the upper portion of the calibration probe 406 and a partial perspective view of a pipette nozzle 306-1 configured for insertion into the calibration probe collet 606, according to an example of the principles described herein. In FIG. 8, the nozzle connection tip 308-1 is illustrated in detail for insertion into the collet 606 via a pathway 804. According to an example, the nozzle connection tip 308-1 may optionally include a detent ring 802 for assisting in holding the pipette nozzle into position in the collet orifice 610 of the collet 606 until the collet 606 is tightened around the nozzle connection tip 308-1. In one example, after the nozzle connection tip 308-1 is inserted into the collet 606, and the collet 606 is tightened, as described herein, the connection of the pipette nozzle 306-1 with the calibration probe 406 provides continuous electrical conductivity from the circuitry of the first pipette 304-1 to the calibration probe tip 408 of the calibration probe 406. Additionally, as illustrated and described herein, the center of the calibration probe 406 may be concentric with the center of the pipette nozzle 306-1. In some cases, the first pipette 304-1 may be designed to include the calibration probe 406 as a single, monolithic component.

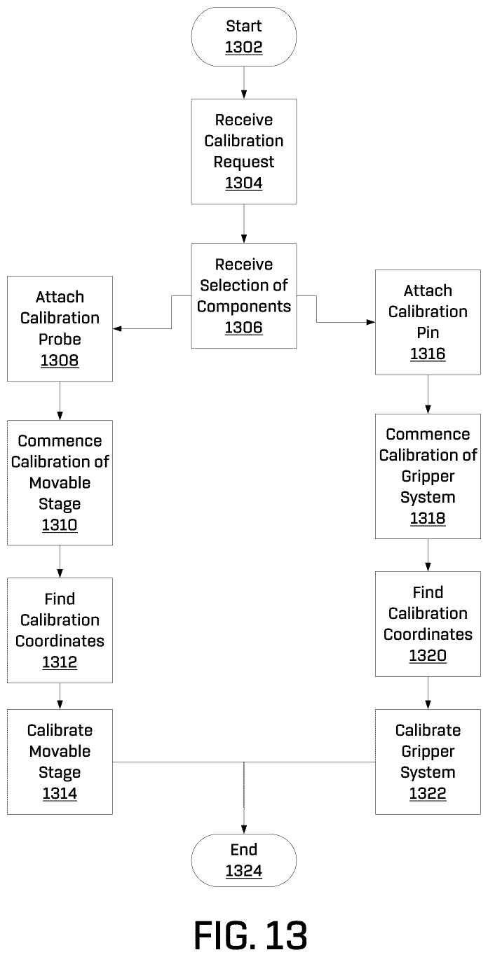

FIG. 9 illustrates a calibration target area of a calibration slot 410, 240 to which a calibration probe is directed for calibrating the moveable stage 104 and associated first pipette 304-1 and pipette nozzle 306-1, according to an example of the principles described herein. As discussed above with reference to FIG. 4, when calibration of the moveable stage 104, including the first pipette 304-1 and the attached the pipette nozzle 306-1 is desired, the calibration probe 406 may be manually or automatically attached to the nozzle connection tip 308-1 as illustrated in FIG. 8. At a high level, the calibration process described further below with reference to FIG. 13, includes finding an edge of each side of the calibration slot 410, 240 at which the calibration slot aperture 414-1, 414-2 starts in the calibration slot 410, 240. That is, by finding the edges of the calibration slot aperture 414-1, 414-2, a geometric center of the calibration target slot 410, 240 may be located. The determined and located geometric center or other location of the calibration slot 410, 240 may be stored for directing the first pipette 304-1 and pipette nozzle 306-1 to that stored location for distributing a liquid or other material into a container or device placed at that location. Alternatively, calibration of the moveable stage assembly 300, including the first pipette 304-1 and the pipette nozzle 306-1, may allow the first pipette 304-1 and the pipette nozzle 306-1 to accurately move to desired locations throughout the deck 106 of the liquid handling system 100.

Upon receiving a command to calibrate the moveable stage assembly 300, including the first pipette 304-1, and the pipette nozzle 306-1 via the UI 118, the first pipette 304-1 and the pipette nozzle 306-1 with the attached calibration probe 406 moves into position over a selected calibration target slot 410, 240, as illustrated in FIG. 4. Referring then to the top illustration 900a of FIG. 9, the calibration probe 406 is first lowered to a position 902 on the surface area of the calibration target slot 410, 240. As should be noted, the calibration probe 406 in FIG. 9 is depicted as a miniature or icon to show where the calibration probe 406 initially lands during calibration, but to avoid obscuring other illustrated features of FIG. 9. The depiction of the calibration probe relative to other components is more accurately illustrated in FIG. 4.

By utilizing previous calibration information for the calibration target slot 410, 240 or known position information for the calibration target slot 410, 240 on the deck 106, the calibration probe 406 is moved to a center of each side of the calibration target slot 410, 240 close to a previously stored position of an edge 904a, 906a, 908a, 910a between the band 412-1, 412-2 and the calibration slot aperture 414-1, 414-2. For each side 904, 906, 908, 910, the calibration probe 406 follows an iterative process of finding a location of the edge. Referring to the illustration 900a at the top of FIG. 9, the calibration probe 406 first moves down to position 902, as illustrated in FIG. 9. As described above with reference to FIGS. 4 and 5, when the calibration probe tip 408 touches the surface of the calibration adapter 402, deck slot cover 240 or other location on the deck 106, contact between the calibration probe tip 408 and the surface allows a momentary discharge of stored charge from the capacitor 514 at the direction of the PCBA 504. The resulting electrical conductivity through the pipette nozzle 306-1 and calibration probe tip 408 to the touched surface allows the liquid handling system 100 to establish the calibration probe tip 408 has reached the surface, as described herein. In one example, when the calibration probe tip 408 touches the surface of the calibration adapter 402, deck slot cover 240 or other location on the deck 106, the PCBA 504 may respond fast enough so that the speed of motion and the time taken to respond causes a variance in position less than a required or desired calibration tolerance.

Referring still to FIG. 9, moving the calibration probe 406 down to the surface at position 902 of the band 412-1, 412-2 around the calibration slot aperture 414-1, 414-2 establishes the z distance between a lower end of the pipette nozzle 306-1 and the surface of the calibration adapter 402, deck slot cover 240 or other location on the deck 106. For example, consider for purposes of illustration that the calibration probe 406 initially touches the surface of the calibration adapter 402, deck slot cover 240 or other location on the deck 106 at position 902 acting as a contact point such that the calibration probe is at position 1 in the listing of probe positions 912 illustrated in FIG. 9. The z distance (vertical distance) down to position 1 is stored, and electrical (e.g., capacitive) contact with the surface of the band 412-1 indicates that the probe has landed on the surface (hereafter referred to as “on deck”). As described herein, the calibration probe 406 may not actually touch the surface, but “touching” of the surface may be detected via capacitive sensing where a capacitive charge generates a small electromagnetic field (in this, about a tip of the calibration probe tip) is generated about the probe tip. When the small EMF field is pierced as the probe tip gets close to or touches the surface, the surface is sensed.

To start the process of finding the first edge 904a, the calibration probe 406 may be next lifted and moved laterally to a second position, for example, position 2, and the calibration probe 406 is lowered the z distance established at position 1. At position 2, no contact is made with a surface of the band 412-1 because position 2 is over the calibration slot aperture 414-1, 414-2. The lack of electrical (i.e., capacitive) contact with the surface over calibration slot aperture 414-1, 414-2 at position 2 indicates that the probe has not landed on the surface of the calibration adapter, deck slot cover or other deck position. Having the calibration probe not landing on the surface of the calibration adapter, deck slot cover or other deck position is referred to hereinafter as quote “not on deck”.

The calibration probe 406 is again lifted and moved laterally, but this lateral movement takes the probe to position 3. That is, in an iterative process, the calibration probe 406 is moved back toward position 1 as it is now known that position 1 is not the first edge 904a. At position 3, the calibration probe 406 is again lowered the z distance to position 3. At position 3, the probe makes electrical contact with the band 412-1 indicating that it has landed on deck. This back-and-forth process is continued iteratively back to position 4 where the calibration probe 406 again lands not on deck, then back to position 5 where the calibration probe 406 lands on deck. With each successive incremental move, the distances of movement of the calibration probe 406 are decreased in order to pinpoint the first edge 904a. According to the example illustrated in FIG. 9, the first edge 904a is ultimately found between positions 5 and 7. In one example, this movement between “on deck” and “not on deck” positions may be performed iteratively via a number of algorithms, for example, a binary search where the position of a target (in this case, the first edge 904a) may be found within a sorted array of positions or values.

In one example, after the first edge 904a is located and stored, the calibration probe 406 moves to another side 906, 908, 910 of the calibration target slot 410, 240 and finds the edge of the second side. As should be appreciated, the order of finding the edges 904a, 906a, 908a, 910a for the respective sides 904, 906, 908, 910 may be accomplished according to any desired order. For example, referring to the depiction 900b, illustrated in FIG. 9, the calibration probe 406 is illustrated as moved to position 914 along the lower side 910 of the calibration target slot 410, 240. The iterative process of moving the calibration probe 406 up and down and laterally to find the “on deck” and “not on deck” positions 1-7 in the set of positions 916 illustrated in the lower left corner of the calibration target slot 410, 240 is then performed. According to this example, the edges 910b is located at position 7 and the location of the edge 910b is stored.

In one example, this iterative process is completed for each side 904, 906, 908, 910 until the edges of each side are located. Knowing the locations of the edges of each side 904, 906, 908, 910 and knowing the dimensions of the calibration target slot 410, 240, the liquid handling system 100 via the computing system 1400 may determine a geometric center 918 or other desired location of the calibration target slot 410, 240. According to one example, the geometric center may be determined by averaging the positions of each edge of the calibration target slot 410, 240. Once the geometric center or other desired location of the calibration target slot 410, 240 is established as a specific x position and y position on the deck 106 and a specific z position (z distance) down to the surface of the band 412-1 around the calibration target slot 410, 240, the moveable stage 104, including the first pipette 304-1 and the pipette nozzle 306-1 subsequently may automatically move to that specific x, y, and z position as required to distribute liquid or other material to a container or devise positioned at that x, y and z position. In addition to calibrating the moveable stage 104, including the first pipette 304-1 and the pipette nozzle 306-1 to a specific position for subsequently distributing a liquid or other material, calibrating the moveable stage 104, including the first pipette 304-1 and the pipette nozzle 306-1 to a specific x, y and z position for a given calibration target slot 410, 240 may also calibrate the moveable stage 104, including the first pipette 304-1 and the pipette nozzle 306-1 for other locations on the deck 106 of the liquid handling system 100 based on knowing the positions of other locations on the deck 106 relative to the x, y and z position located during the calibration process.

In one example, fewer than all the edges 904a, 906a, 908a, 910a for the respective sides 904, 906, 908, 910 may be detected during the calibration process described herein. For example, two of the edges 904a, 906a, 908a, 910a may be detected where a first one of the edges 904a, 906a, 908a, 910a is detected followed by a second one of the edges 904a, 906a, 908a, 910a that runs perpendicularly to the first one of the edges 904a, 906a, 908a, 910a. In this example, the geometric center 918 may be determined given a knowledge of the shape and size of the calibration slot aperture 414.

As discussed above, the calibration process described for the moveable stage 104, including the first pipette 304-1 and the pipette nozzle 306-1 may be used to calibrate gripper arms used in the liquid handling system 100 for moving, positioning and removing containers or devices, for example, test tubes, beakers, testing apparatuses, and the like to and from various positions on the deck 106 of the liquid handling system 100. FIG. 10 illustrates a pair of material handling system gripper arms with gripper jaws and illustrates a calibration pin for calibrating components of a material handling gripper system, according to an example of the principles described herein. As illustrated in FIG. 10, a robotic material handling gripper system 1000 is provided for positioning, moving, repositioning and removing containers or devices to various locations of the deck 106 of the liquid handling system 100 In one example. The robotic material handling gripper system 1000 (hereafter “gripper system”) may be connected to the moveable stage 104 illustrated in FIG. 1 or may operate independently of the moveable stage 104 by traveling along the x-axis moveable truss 110 in the same manner as the moveable stage 104, as described above with reference to FIG. 1.

The gripper system 1000 includes a gripper gantry 1004 from which may hang a pair of gripper arms 1006-1, 1006-2. At the lower ends of the gripper arms 1006-1, 1006-2, gripper jaws 1008-1, 1008-2 are affixed to the gripper arms. An optional gripper jaw pad 1012 is disposed on an interior surface of the gripper jaws 1008-1, 1008-2 for assisting the gripper jaws 1008-1, 1008-2 to grip a container or device. In one example, control circuitry in the gripper system 1002 (e.g., the gripper gantry 1004 or in the gripper arms 1006-1, 1006-2) may be programmed or otherwise commanded to move containers or devices around the interior of the liquid handling system 100 by squeezing (gripping) the gripper arms 1006-1, 1006-2 together to capture a container or device. In one example, the gripper jaws 1008-1, 1008-2 and associated optional gripper jaw pads 1012 may squeeze together via movement of the gripper arms 1006-1, 1006-2 to capture a container or device. The container or device may be released at a given position by moving the gripper arms apart after the container or device is placed at the desired position.

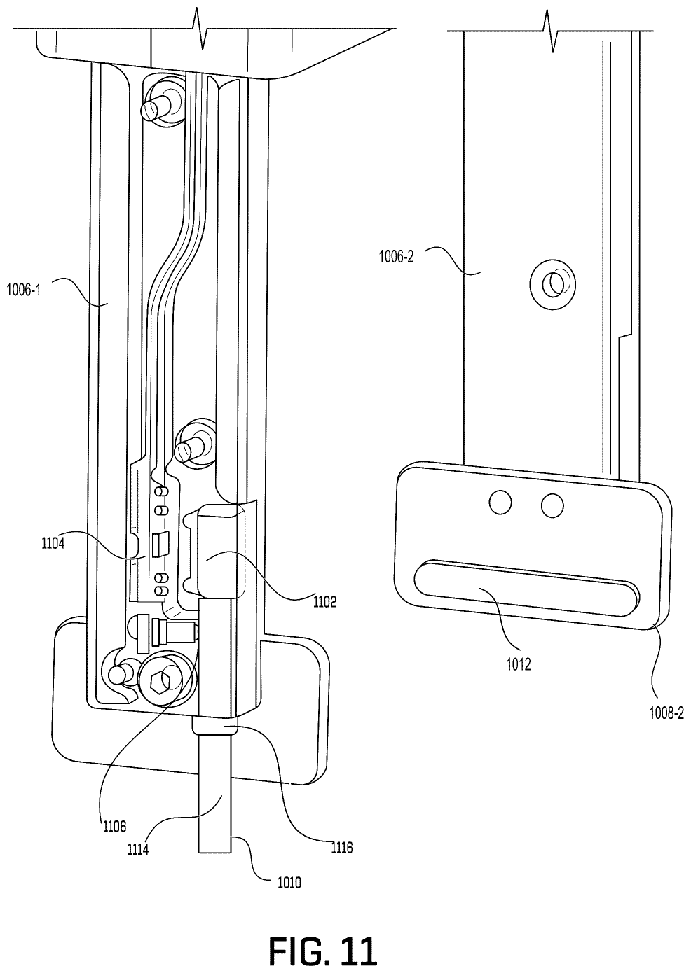

Referring still to FIG. 10, the gripper arm 1006-1 is positioned over the first small deck slot cover 224-1 and the calibration target slot for 240, as illustrated and described above. A gripper calibration pin 1010 is affixed to the gripper arm 1006-1 for calibrating the gripper arm 1006-1 in the same manner as described above for the calibration probe 406. The gripper calibration pin 1010 is illustrated as a generally tube-shaped pin, but the gripper calibration pin 1010 may have other shapes with, for example, a square or rectangular cross section. In one example, the gripper calibration probe or pin 1010 (hereafter “gripper calibration pin”) may be affixed to the other gripper arm 1006-2 for calibrating the other gripper on 1006-2. As with the moveable stage assembly 300, including the first pipette 304-1 and pipette nozzle 306-1, discussed above, a PCBA 1104 (FIG. 11) may be used to control operations of the gripper arm 1006-1, 1006-2 including calibration of the gripper system 1000, as described herein.

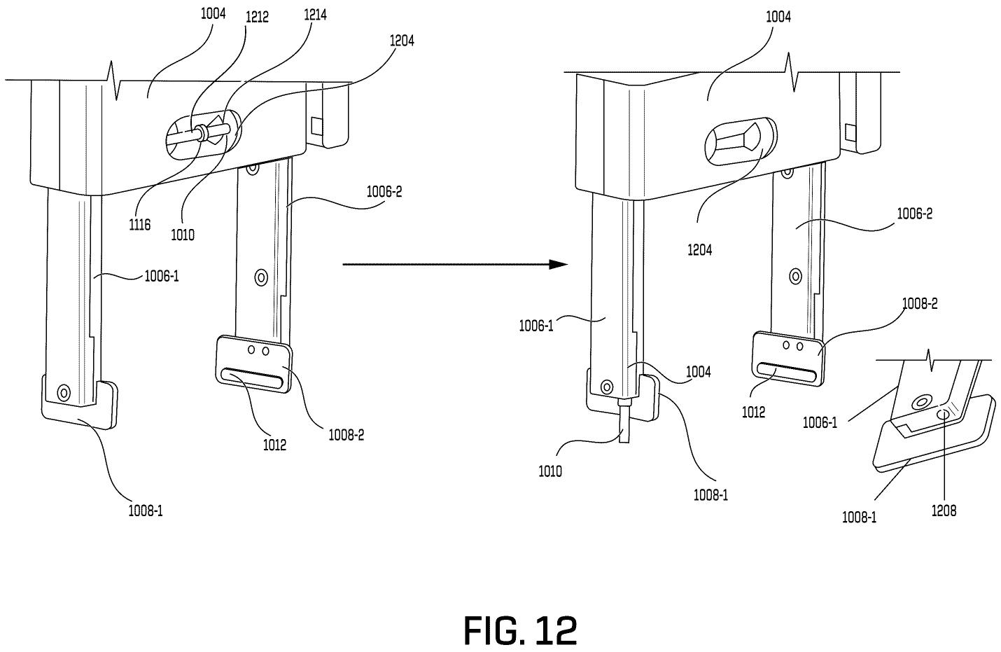

FIG. 11 illustrates an open view of one of the calibration gripper arms of FIG. 10 showing partial internal components of the illustrated gripper arms and calibration pin, according to an example of the principles described herein. As illustrated in FIG. 11, the gripper calibration pin 1010 may be inserted into a gripper pin orifice 1208 (FIG. 12) such that an upper end 1214 (FIG. 12) of the gripper calibration pin 1010 contacts a magnet 1102 to hold the gripper calibration pin 1010 into position during calibration of the gripper arms 1006-1, 1006-2. In one example, a retainer band 1116 is disposed circumferentially around the gripper calibration pin 1010 for stopping travel of the upper end 1214 against the magnet 1102 and for securing any unwanted motion of the gripper calibration pin 1010 inside the lower end of the gripper arm 1006-1.

Referring still to FIG. 11, the gripper calibration pin 1010 operates via a capacitance system in the same manner as the calibration probe 406 described for calibration of the moveable stage assembly 300, including the first pipette 304-1 and pipette nozzle 306-1. That is, when a lower end of the gripper calibration pin 1010 (made of a conductive material such as metal) touches a conductive surface on the deck 106 of the liquid handling system 100, a stored electrical charge in the capacitor associated with the PCBA 1104 provides an electrical conductive signal through an electrical contact 1106 in conductive connection with the upper end 1214 of the gripper calibration pin 1010 via monitoring of an electromagnetic field or force (EMF). The capacitive signaling allows a touch of the lower end of the gripper calibration pin 1010 to signal to the PCBA 1104 that the gripper calibration pin 1010 is “on deck” as it comes into contact with the conductive surface of the calibration target slot 240 of the first small deck slot cover 224-1 in the same manner as described above with reference to the calibration probe 406.

FIG. 12 illustrates the material handling gripper arms with gripper jaws of FIG. 11 and illustrates deployment of the calibration pin for calibrating the material handling gripper system, according to an example of the principles described herein. As illustrated in FIG. 12, the gripper calibration pin 1010 is stored in a calibration pin receptacle 1204. The gripper calibration pin 1010 with its upper end 1214, lower end 1212 and retainer band 1116 are stored in the calibration pin receptacle 1204 until it is needed for calibrating the gripper system 1000. According to other examples, the gripper calibration pin 1010 may be stored by securing the pin by screwing in or twist-locking the pin in a hole in one of the gripper arms. In other examples, the gripper calibration pin 1010 may be stored on the deck 106 or a cradle module (FIG. 1). A user may be prompted by a software application via the UI 118 to place the stored gripper calibration pin 1010 in a first of the available gripper arms. In response, user may place the gripper calibration pin 1010 in the gripper pin orifice 1208, as described below.

Prior to starting a calibration process, the gripper calibration pin 1010 is removed from the calibration pin receptacle 1204, and the upper or lower end of the gripper calibration pin 1010 is inserted into the gripper pin orifice 1208 until the upper end 1212 or the lower end 1214 engages the magnet 1102 and contacts the electrical contact 1106 as described above with reference to FIG. 11. In one example, the calibration probe or pin orifice includes a pathway into the lower end of the gripper arm in longitudinal alignment with the gripper arm. The pathway has a depth corresponding to a length of the gripper calibration pin 1010 shaft extending from the upper end or the lower end of the calibration pin shaft to the retainer band 1116.

After calibration of the first gripper arm 1006-1 as described below, the gripper calibration pin is removed from the gripper pin orifice 1208 of the first gripper arm and is inserted into a corresponding gripper pin orifice 1208 of the second gripper arm 1006-2 for calibration of the second gripper arm 1006-2. As should be appreciated, if the gripper system 1000 has more than two gripper arms, the calibration process described herein may be repeated for all available gripper arms of the gripper system 1000.

In one example, the calibration process for each of the gripper arms 1006-1, 1006-2 is the same as described above for the moveable stage assembly 300, including the first pipette 304-1 and pipette nozzle 306-1. That is, referring back to FIGS. 9 and 10, for each gripper arm, the arm is lowered until the lower end 1212 of the gripper calibration pin 1010 makes contact with a surface of the band 412-2 of the calibration target slot 240. Contact of the gripper calibration pin 1010 with the conductive surface of the band 412-2 caused electrical capacitance discharge through the gripper calibration pin 1010 to signal the PCBA 1104 of the pin's contact with the surface. After lowering the gripper calibration pin to the surface, the calibration process may start and proceed as described above with reference to FIG. 9. That is, having established a z distance for the gripper calibration pin from a raised position to a point of contact, the gripper calibration pin may then be moved in the iterative up and down and lateral movement to locate each edge 904a, 906a, 908a, 910a of the calibration target slot 240. As with the calibration probe 406, after each edge is identified, the x, y, and z coordinates of the center 918 may be established. The x, y and z coordinates are stored. After the second gripper arm 1006-2 is calibrated, the calibrated gripper system 1000 may then be used to accurately transport containers or devices to and from the target location at the determined x, y and z coordinates. As with calibration of the moveable stage assembly 300, including the first pipette 304-1 and pipette nozzle 306-1, the gripper, calibration of the gripper system 1000 also allows it to accurately move to different locations of the liquid handling system 100 for transporting containers and devices distributed thereon.

FIG. 13 illustrates a flow diagram of an example method 1300 of calibrating components of the liquid handling system 100, according to an example of the principles described herein. At step 1302, the method 1300 begins. At step 1304, a request is received to calibrate one or more components of the liquid handling system 100. For example, a user may determine a need for calibrating one or more components of liquid handling system 100 described herein owing to errors or quality control issues that may have been experienced from either the moveable stage assembly 300, including the first pipette 304-1 and pipette nozzle 306-1 as determined by quality control analysis, for example, where it may be determined that a distribution of liquids or other materials from the pipette nozzle 306-1 are slightly off target from a receptacle, for example, a test tube into which liquids or other materials are distributed. Alternatively, the request to calibrate one or more components of the liquid handling system 100 may be in response to a standard calibration protocol, for example, where the one or more components of the liquid handling system 100 are calibrated from time-to-time, for example, once per day, once per week, once per month, and the like. The request or the need to calibrate one or more components of the liquid handling system 100 may also be directed to the gripper system 1000 for the same or similar reasons as described above for the moveable stage assembly 300, including the first pipette 304-1 and pipette nozzle 306-1.

In one example, the request to calibrate one or more components of the liquid handling system 100 may be a manual request wherein a user initiates the request by selecting the calibration of one or more components of the liquid handling system via the UI 118, described above with reference to FIG. 1. Alternatively, if calibration of one or more components of the liquid handling system 100 is performed on a periodic basis, a user of the liquid handling system 100 may receive a prompt via the UI 118 that calibration of one or more components of liquid handling system 100 is required according to a scheduled calibration requirement.

At step 1306, in response to the request or need for calibrating one or more components of the liquid handling system 100, the one or more components requiring calibration are selected via the UI 118, or via an alternative functionality available to the user for engaging or commencing calibration of the one or more components of the liquid handling system 100. In one example, the user may select to calibrate components of the moveable stage assembly 300, including the first pipette 304-1 and pipette nozzle 306-1, or the user may select calibration for the gripper system 1000.

If the user selects the moveable stage assembly 300, including the first pipette 304-1 and pipette nozzle 306-1 for calibration, the method 1300 proceeds to step 1308, and the calibration probe 406 is attached to the nozzle connection tip 308-1 of the first pipette 304-1, as described above with reference to FIG. 8. As described herein, the calibration probe 406 may be attached to the nozzle connection tip 308-1 manually, or the calibration probe 406 may be attached to the nozzle connection tip 308-1 automatically. If the calibration probe 406 is attached to the nozzle connection tip 308-1 manually, a user retrieves the calibration probe 406 and inserts the nozzle connection tip 308-1 into the collet orifice 610 of the collet 606. After placement of the nozzle connection tip 308-1 into the collet 606, the user manually turns the collet compression or tightening sleeve 510 to engage the collet threads 604 with the receiver threads 612 which causes the rotatable sleeve to rotatably traverse upward and to squeeze the collet 606 around the nozzle connection tip 308-1. If the calibration probe 406 is affixed to the nozzle connection tip 308-1 automatically, a robotic gripper system, such as the gripper system 1000, described herein, may automatically retrieve the calibration probe 406 and robotically place the calibration probe 406 onto the nozzle connection tip 308-1 in the same manner as performed manually by user. After inserting the nozzle connection tip 308-1 into the collet 606, the robotic gripper system may automatically turn the collet compression or tightening sleeve 510 to tighten the collet 606 around the nozzle connection tip 308-1.

After the calibration probe 406 is secured to the pipette 306-1, as described above, the method proceeds to step 1310, and the user may be prompted via the UI 118 to commence calibration. As should be understood, the decision to commence calibration will be directed to a particular location on the deck 106 of the liquid handling system 100. For example, the decision or the requirement or need to calibrate the moveable stage assembly 300, including the first pipette 304-1 and the pipette nozzle 306-1, may be directed to the calibration target slot 410, 240, as described above with reference to FIG. 4. Alternatively, the user may select a location requiring or needing calibration from a list of locations accessible via the U118. According to another alternative, if the need to calibrate the moveable stage assembly 300 and associated components has arisen due to a quality control issue, the user may be prompted via the UI 118 to calibrate a particular location on the deck 106 of the liquid handling system 100. At step 1310, the user may selectively commence calibration via the UI 118.

In response to commencement of calibration at step 1310, the moveable stage assembly 300 moves to the location of the required or selected calibration. As described above with reference to FIG. 9, the moveable stage assembly 300 lowers the first pipette 304-1, pipette nozzle 306-1, and the affixed calibration probe 406 until the calibration probe tip 408 touches a surface near the calibration target slot 410, 240 near an edge 904a, 906a, 908a, 910a of the calibration target slot 410, 240, as described above with reference to FIG. 9. The liquid handling system 100 via liquid handling computing system 1400 begins the iterative calibration process, described above with reference to FIG. 9.

At step 1312, as described above with reference to FIG. 9, the computing system 1400, described below, causes the calibration probe 406 to commence the up and down and lateral movement technique, for determining the edge 904a, 906a, 908a, 910a of the square or rectangular shaped calibration target slot 410, 240. After all edges 904a, 904a, 908a, 910a are determined, a geometric center 918 or other location in the calibration target slot 410, 240 is determined, and the x, y, and z coordinates for the determined geometric center 918 or other location in the calibration target slot 410, 240 are stored.

At step 1314, the x, y, and z coordinates of the determined geometric center 918 or other location in the calibration target slot 410, 240 are used for calibrating the moveable stage assembly 300 and associated components to the determined x, y, and z coordinates. That is, as described above with reference to FIG. 9, once the liquid handling system 100 through the computing system 1400 knows the precise movements required for moving the moveable stage assembly 300 and associated components to the precise location of the determined x, y and z coordinates, the moveable stage assembly 300 and associated components may be calibrated to repeat the determined movements to move the components of the moveable stage assembly 300 and associated components, for example, the pipettes 304-1, 304-2 to the particular location of the determined x, y and z coordinates. Alternatively, the calibration of the moveable stage assembly 300 may be used for adjusting movements of the moveable stage assembly 300 and associated components for calibrating the moveable stage assembly and associated components for movement to any location on the deck 106 of liquid handling system 100.

Referring back to step 1306, if the user selects the gripper system 1000 for calibration, the method proceeds to step for calibration, the method 1300 proceeds to step 1316, and the gripper calibration pin 1010 is attached to the first of one or more gripper arms 1006-1, as described above with reference to FIGS. 10-12. As described herein, the gripper calibration pin 1010 may be attached to the gripper arm 1006-1 by inserting one end of the gripper calibration pin into the gripper pin orifice 1208 until the inserted end contacts the magnet 1102.

After the gripper calibration pin is secured to the gripper arm 1006-1, as described above, the method proceeds to step 1318, and the user may be prompted via the UI 118 to commence calibration. As should be understood, the decision to commence calibration will be directed to a particular location on the deck 106 of the liquid handling system 100. For example, the decision or the requirement or need to calibrate the gripper system 1000, may be directed to the calibration target slot 410, 240, as described above with reference to FIG. 4. Alternatively, the user may select a location requiring or needing calibration from a list of locations accessible via the U118. According to another alternative, if the need to calibrate the gripper system 1000 and associated components has arisen due to a quality control issue, the user may be prompted via the UI 118 to calibrate a particular location on the deck 106 of the liquid handling system 100. At step 1318, the user may selectively commence calibration via the UI 118.

At step 1318, calibration of the selected gripper system 1000 begins. The gripper system 1000 moves to the location of the required or selected calibration. As described above with reference to FIGS. 9-12, the gripper system 1000 lowers the gripper arm 1006-1 and the affixed gripper calibration pin 1010 until the gripper calibration pin 1010 touches a surface near the calibration target slot 410, 240 near an edge 904a, 906a, 908a, 910a of the calibration target slot 410, 240, as described above with reference to FIGS. 9-12. The liquid handling system 100 via computing system 1400 begins the iterative calibration process, described above with reference to FIG. 9.

At step 1320, as described above with reference to FIGS. 9-12, the computing system 1400, described below, causes the gripper calibration pin to commence the up and down and lateral movement technique, for determining the edge 904a, 906a, 908a, 910a of the square or rectangular shaped calibration target slot 410, 240. After all edges 904a, 904a, 908a, 910a are determined, a geometric center 918 or other location in the calibration target slot 410, 240 is determined, and the x, y, and z coordinates for the determined geometric center 918 or other location in the calibration target slot 410, 240 are stored.

At step 1322, the x, y, and z coordinates of the determined geometric center 918 or other location in the calibration target slot 410, 240 are used for calibrating the gripper system 1000 and associated components to the determined x, y, and z coordinates. That is, as described above with reference to FIGS. 9-12, once the liquid handling system 100 through the computing system 1400 knows the precise movements required for moving the gripper system 1000 and associated components to the precise location of the determined x, y and z coordinates, the gripper system 1000 and associated components may be calibrated to repeat the determined movements to move the components of the gripper system 1000 and associated components to the particular location of the determined x, y and z coordinates. Alternatively, the calibration of the gripper system 1000 and associated components may be used for adjusting movements of the gripper system 1000 and associated components for calibrating the gripper system 1000 and associated components for movement to any location on the deck 106 of liquid handling system 100.

The method 1300 may end at step 1324 or the method 1300 may be performed again and any number of times thereafter.

FIG. 14 illustrates a computing system diagram illustrating a configuration for a computing system 1400 that may be utilized to implement aspects of the principles described herein. The computing system 1400 may include a baseboard 1402, or “motherboard,” which is a printed circuit board to which a multitude of components or devices may be connected by way of a system bus or other electrical communication paths. In one example, one or more central processing units (“CPUs”) 1404 operate in conjunction with a chipset 1406. The CPUs 1404 may be standard programmable processors that perform arithmetic and logical operations necessary for the operation of the liquid handling system 1400.

The CPUs 1404 perform operations by transitioning from one discrete, physical state to the next through the manipulation of switching elements that differentiate between and change these states. Switching elements may include electronic circuits that maintain one of two binary states, such as flip-flops, and electronic circuits that provide an output state based on the logical combination of the states of one or more other switching elements, such as logic gates. These switching elements may be combined to create more complex logic circuits, including registers, adders-subtractors, arithmetic logic units, floating-point units, and the like.

The chipset 1406 provides an interface between the CPUs 1404 and the remainder of the components and devices on the baseboard 1402. The chipset 1406 may provide an interface to a RAM 1408, used as the main memory in the liquid handling system 1400. The chipset 1406 may further provide an interface to a computer-readable storage medium such as a read-only memory (“ROM”) 1410 or non-volatile RAM (“NVRAM”) for storing basic routines that help to start up the liquid handling system 100 (FIG. 1) and to transfer information between the various components and devices, described herein. The ROM 1410 or NVRAM may also store other software components necessary for the operation of the liquid handling system 100 in accordance with the configurations described herein.

The computing system 1400 may operate in a networked environment using logical connections to remote computing devices and computer systems through a network, such as the network 1430. The chipset 1406 may include functionality for providing network connectivity through a network interface controller (NIC) 1412, such as a gigabit Ethernet adapter. The NIC 1412 is capable of connecting the liquid handling system 1400 to other computing devices over the network 1430. It should be appreciated that multiple NICs 1412 may be present in the computing system 1400, connecting the computer to other types of networks and remote computer systems. The liquid handling system 100 may be connected to an instructing device 1428. The instructing device 1428 may include any computing device apart from the computing elements of the liquid handling system 1400 that may be used to provide instructions and/or programming to the liquid handling system 1400. In one example, the instructing device 1428 may be included “as a service” (aaS) in which a product use is offered as a service (e.g., as a subscription-based service) rather than as an artifact owned and maintained by the user.

The computing system 1400 may be connected to a storage device 1422 that provides non-volatile storage for the computing system 1400. The storage device 1422 may store an operating system 1424, programs 1426, and data. The storage device 1422 may be connected to the computing system 1400 through a storage controller 1414 connected to the chipset 1406. The storage device 1422 may include one or more physical storage units. The storage controller 1414 may interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computing system 1400 may store data on the storage device 1422 by transforming the physical state of the physical storage units to reflect the information being stored. The specific transformation of physical state may depend on various factors, in different embodiments of this description. Examples of such factors may include, but are not limited to, the technology used to implement the physical storage units, whether the storage device 1422 is characterized as primary or secondary storage, and the like.

For example, the computing system 1400 may store information to the storage device 1422 by issuing instructions through the storage controller 1414 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computing system 1400 may further read information from the storage device 1422 by detecting the physical states or characteristics of one or more particular locations within the physical storage units.

In addition to the mass storage device 1422 described above, the liquid handling system 1400 may have access to other computer-readable storage media to store and retrieve information, such as program modules, data structures, or other data. It should be appreciated by those skilled in the art that computer-readable storage media is any available media that provides for the non-transitory storage of data and that may be accessed by the liquid handling system 100. In one example, the operations performed by the liquid handling system 100, and or any components included therein, may be supported by one or more devices similar to computing system 1400. Stated otherwise, some or all of the operations performed by the liquid handling system 100, and/or any components included therein, may be performed by one or more computing devices operating in a cloud-based arrangement.

By way of example, and not limitation, computer-readable storage media may include volatile and non-volatile, removeable and non-removeable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that may be used to store the desired information in a non-transitory fashion.

As mentioned briefly above, the storage device 1422 may store an operating system 1424 utilized to control the operation of the liquid handling system 1400. According to one embodiment, the operating system 1424 may include the LINUX operating system. According to another example, the operating system may include the WINDOWS® SERVER operating system from MICROSOFT Corporation of Redmond, Washington. According to further examples, the operating system 1424 may include the UNIX operating system or one of its variants. It should be appreciated that other operating systems may also be utilized. The storage device 1422 may store other system or application programs and data utilized by the liquid handling system 1400.

In one example, the storage device 1422 or other computer-readable storage media is encoded with computer-executable instructions which, when loaded into the computing system 1400, transform the computer from a general-purpose computing system into a special-purpose computer capable of implementing the embodiments described herein. These computer-executable instructions transform the computing system 1400 by specifying how the CPUs 1404 transition between states, as described above. According to one example, the computing system 1400 has access to computer-readable storage media storing computer-executable instructions which, when executed by the computing system 1400, perform the various processes described above herein. The computing system 1400 may also include computer-readable storage media having instructions stored thereupon for performing any of the other computer-implemented operations described herein.

The computing system 1400 may also include one or more input/output controllers 1416 for receiving and processing input from a number of input devices, such as a user interface (UI) 118, a keyboard, a mouse, a touchpad, a touch screen, an electronic stylus, or other type of input device. Similarly, an input/output controller 1416 may provide output to a display, such as the UI 118, a computer monitor, a flat panel display, a digital projector, a printer, or other type of output device. It will be appreciated that the computing system 1400 might not include all of the components shown in FIG. 14, may include other components that are not explicitly shown in FIG. 14, or might utilize an architecture completely different than that shown in FIG. 14.

The UI 118 may include any user input and/or output device as described above in connection with the devices associated with the input/output controllers 1416. The UI 118 may include, for example, a tactile UI (e.g., touch), visual UI (e.g., sight), auditory UI (e.g., sound), other types of UI devices, and combinations thereof. The UI 118 may be utilized by the user to receive information and instructions from the computing system 1400 as to how to operate the liquid handling system 100 including, for example, attaching a calibration probe 406 or gripper calibration pin 1010 to begin calibration processes described herein. As this is one aspect of the present systems and methods, a process by which the user may interface with the UI 118 will now be described.

Turning again to FIG. 14, the computing system 1400 may further include liquid handling system hardware 1420. The liquid handling system hardware 1420 may include all the various components of the liquid handling system 100, for example, moveable stage assembly 300, including the first pipette 304-1 and pipette nozzle 306-1 and the gripper system 1000. Further, the liquid handling system hardware 1420 may include, for example, a deck, cradle devices coupled to the deck, and any type of modules that may be coupled to the cradle devices and used to process the liquids dispensed by the liquid handling system 100. The modules that may be coupled to the cradle devices and used to process the liquids dispensed by the liquid handling system 100 may include, for example, a temperature deck, a heat shaker, a thermocycler, a heating device, a cooling device, a vacuum pump, a centrifuge, a liquid handler, a tube handling device, a sealing device, an unsealing device, a magnetic device, other modules, and combinations thereof. Further, the liquid handling system hardware 1420 may include the housing of the liquid handling system 100 and any other elements of the liquid handling system 100.

Although the elements described in connection with FIG. 14 are depicted as being connected directly or indirectly via, for example, the LAN 1430, the elements may be included entirely in the liquid handling system 100 or dispersed among any number of separate devices and across any number of computing networks. For example, the instructing device 1428 may be located directly within the liquid handling system 100 as opposed to connected through the LAN 1430.

### Example Clauses

A: A pipette calibration probe, comprising: a calibration probe shaft; a collet disposed at an upper end of the calibration probe shaft; a set of collet threads disposed circumferentially around the calibration probe shaft beneath the collet; a collet compression sleeve housing rotatably disposed around the calibration probe shaft, the collet compression sleeve housing including a set of receiver threads disposed circumferentially around an interior surface of the collet compression sleeve housing; and the set of receiver threads rotatably engaged with the set of collet threads to rotatably traverse an upper end of the collet compression sleeve housing upward onto the collet and to rotatably traverse the upper end of the collet compression sleeve housing downward off the collet.
B: The pipette calibration probe according to paragraph A, wherein the collet compression sleeve housing is operative to rotatably traverse upward via engagement of the set of receiver threads with the set of collet threads to compress the collet into a closed configuration; and the collet compression sleeve housing is operative to rotatably traverse downward via engagement of the set of receiver threads with the set of collet threads to decompress the collet into an open configuration.
C: The pipette calibration probe according to paragraphs A-B, wherein the collet includes a compression slot defined longitudinally from an upper end of the collet to a lower end of the collet; the collet is compressed into a closed configuration by compression of the compression slot from an open configuration to a closed configuration; and the collet is decompressed into an open configuration by decompression of the compression slot from a closed configuration to an open configuration.
D: The pipette calibration probe according to paragraphs A-C, wherein compression of the compression slot is caused by an upward traversal of the upper end of the collet compression sleeve housing onto the collet; and decompression of the compression slot is caused by a downward traversal of the upper end of the collet compression sleeve housing off the collet.
E: The pipette calibration probe according to paragraph A, wherein the collet includes an orifice defined in an upper end of the collet, the orifice being in longitudinal alignment with the calibration probe shaft.
F: The pipette calibration probe according to paragraphs A and E, wherein the orifice in the upper end of the collet is configured to receive a lower end of a pipette nozzle wherein the lower end of the pipette nozzle is in longitudinal alignment with the calibration probe shaft.
G: The pipette calibration probe according to paragraphs A and E-F, wherein the collet is affixed to the pipette nozzle when an upper end if the collet compression sleeve housing is rotatably traversed onto the collet.
H: The pipette calibration probe according to paragraphs A and E-F, wherein the calibration probe shaft is comprised of an electrically conductive material, the pipette nozzle is comprised of an electrically conductive material, the pipette nozzle and the pipette calibration probe are coupled by inserting the lower end of the pipette nozzle into the orifice, and coupling of the pipette nozzle with the pipette calibration probe provides a continuous electrical conductivity path through the pipette nozzle to and through the calibration probe shaft.
I: The pipette calibration probe according to paragraphs A, E-F and H, wherein contact of a lower tip of the calibration probe shaft with a surface at a calibration location provides electrical conductivity from a pipette through the pipette nozzle through the calibration probe shaft and to the surface.
J. The pipette calibration probe according to paragraphs A, E-F and H-I, wherein electrical conductivity from the pipette through the pipette nozzle through the calibration probe shaft and to the surface provides for capacitive sensing of a point of contact of the lower tip of the calibration probe shaft with the surface.
K. The pipette calibration probe according to paragraphs A, E-F and H-J, wherein providing for capacitive sensing includes providing an electromagnetic field about the lower tip of the calibration probe shaft enabling sensing of the point of contact when the lower tip of the calibration probe shaft is proximal to the surface.
L: A gripper arm calibration system, comprising a gripper arm including a calibration probe orifice defined in a lower end of the gripper arm; a magnet disposed in an interior of the calibration probe orifice; and a calibration probe including a calibration probe shaft, the calibration probe shaft including an upper end and a lower end and including a retainer band disposed circumferentially around the calibration probe shaft between the upper end and the lower end, wherein the upper end and the lower end of the calibration probe shaft are configured to be inserted into the calibration probe orifice until the upper end or the lower end of the calibration probe shaft contacts the magnet to hold the calibration probe shaft in the calibration probe orifice.
M: The gripper arm calibration system according to paragraph L, wherein the calibration probe orifice includes a pathway into the lower end of the gripper arm in longitudinal alignment with the gripper arm, the pathway including a depth corresponding to a length of the calibration probe shaft extending from the upper end or the lower end of the calibration probe shaft to the retainer band; and the magnet disposed in an interior of the calibration probe orifice being further disposed at an end of the pathway configured to magnetically engage the upper end or the lower end of the calibration probe shaft.
N: The gripper arm calibration system according to paragraph L further comprising an electrical contact disposed in an interior of the lower end of the gripper arm, the electrical contact configured to contact with the upper end or the lower end of the calibration probe shaft.
O: The gripper arm calibration system according to paragraphs L and N, wherein the calibration probe shaft is comprised of an electrically conductive material; and contacting the electrical contact with the upper end or the lower end of the calibration probe shaft provides a continuous electrical conductivity path from the gripper arm through the calibration probe shaft.
P: The gripper arm calibration system according to paragraphs L, N-O, wherein contact of a lower tip of the calibration probe shaft with a surface at a calibration location provides electrical conductivity from the gripper arm through the calibration probe shaft and to the surface.
Q: The gripper arm calibration system according to paragraphs L, N-P, wherein providing a continuous electrical conductivity path from the gripper arm through the calibration probe shaft and to the surface provides for capacitive sensing of a point of contact of the lower tip of the calibration probe shaft with the surface.
R: The gripper arm calibration system according to paragraphs L, N-Q, wherein providing for capacitive sensing includes providing an electromagnetic field about the lower tip of the calibration probe shaft enabling sensing of the point of contact when the lower tip of the calibration probe shaft is proximal to the surface.
S: A liquid handling system calibration system, comprising: a liquid handling system including a moveable component for transporting materials or devices to one or more locations on a deck of the liquid handling system; and a calibration probe affixed to a lower end of the moveable component for calibrating the moveable component, the calibration probe providing electrical conductivity from the moveable component through the calibration probe for providing capacitive sensing of a point of contact of a lower tip of the calibration probe with a surface, wherein the liquid handling system: lowers the lower tip of the calibration probe to a point on the surface near an edge of a target calibration slot defined the surface, the target calibration slot including a calibration aperture defined in surrounded by a plurality of edges between the calibration aperture and a surface area around the calibration aperture; iteratively raises, lowers, and moves the lower tip of the calibration probe until the plurality of edges are located; determines a geometric center or other specific point in the calibration aperture based on the plurality of edges as located; and calibrates the moveable component to the geometric center or other specific point in the calibration aperture as determined.
T: The liquid handling system calibration according to paragraph S, wherein the moveable component includes at least one of a moveable stage assembly including a pipette and pipette nozzle and a gripper system arm.

While the example clauses described above are described with respect to one or more implementations, it should be understood that, in the context of this document, the content of the example clauses can also be implemented via a method, device, system, computer-readable medium, and/or another implementation. Additionally, any of examples A-T may be implemented alone or in combination with any other one or more of the examples A-T.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

### CONCLUSION

The examples described herein provide for calibration of components of a liquid handling system. Each of a moveable stage and associated attachments (e.g., pipette) and a material handling gripper system are calibrated from time-to-time. In the case of the moveable stage and associated attachments, an affixed calibration probe may be used to locate a particular spatial location at a calibration target slot. In the case of the material handling gripper system, an affixed calibration pin similarly may be used to locate a particular spatial location at a calibration target slot. Based on the movements of the moveable stage and associated attachments and the material handling gripper system to move to and find the particular spatial location, each of these systems may be calibrated.

While the present systems and methods are described with respect to the specific examples, it is to be understood that the scope of the present systems and methods are not limited to these specific examples. Since other modifications and changes varied to fit particular operating requirements and environments will be apparent to those skilled in the art, the present systems and methods are not considered limited to the example chosen for purposes of disclosure and covers all changes and modifications which do not constitute departures from the true spirit and scope of the present systems and methods.

Although the application describes examples having specific structural features and/or methodological acts, it is to be understood that the claims are not necessarily limited to the specific features or acts described. Rather, the specific features and acts are merely illustrative of some examples that fall within the scope of the claims of the application.

What is claimed is:

1. A pipette calibration probe, comprising:
a calibration probe shaft;
a collet disposed at an upper end of the calibration probe shaft;
a set of collet threads disposed circumferentially around the calibration probe shaft beneath the collet;
a collet compression sleeve housing rotatably disposed around the calibration probe shaft, the collet compression sleeve housing including a set of receiver threads disposed circumferentially around an interior surface of the collet compression sleeve housing; and
the set of receiver threads rotatably engaged with the set of collet threads to rotatably traverse an upper end of the collet compression sleeve housing upward onto the collet and to rotatably traverse the upper end of the collet compression sleeve housing downward off the collet.

2. The pipette calibration probe of claim 1, wherein:
the collet compression sleeve housing is operative to rotatably traverse upward via engagement of the set of receiver threads with the set of collet threads to compress the collet into a closed configuration; and
the collet compression sleeve housing is operative to rotatably traverse downward via engagement of the set of receiver threads with the set of collet threads to decompress the collet into an open configuration.

3. The pipette calibration probe of claim 2, wherein:
the collet includes a compression slot defined longitudinally from an upper end of the collet to a lower end of the collet;
the collet is compressed into a closed configuration by compression of the compression slot from an open configuration to a closed configuration; and
the collet is decompressed into an open configuration by decompression of the compression slot from a closed configuration to an open configuration.

4. The pipette calibration probe of claim 3, wherein:
compression of the compression slot is caused by an upward traversal of the upper end of the collet compression sleeve housing onto the collet; and
decompression of the compression slot is caused by a downward traversal of the upper end of the collet compression sleeve housing off the collet.

5. The pipette calibration probe of claim 1, wherein the collet includes an orifice defined in an upper end of the collet, the orifice being in longitudinal alignment with the calibration probe shaft.

6. The pipette calibration probe of claim 5, wherein the orifice in the upper end of the collet is configured to receive a lower end of a pipette nozzle wherein the lower end of the pipette nozzle is in longitudinal alignment with the calibration probe shaft.

7. The pipette calibration probe of claim 6, wherein the collet is affixed to the pipette nozzle when an upper end if the collet compression sleeve housing is rotatably traversed onto the collet.

8. The pipette calibration probe of claim 6, wherein:
the calibration probe shaft is comprised of an electrically conductive material,
the pipette nozzle is comprised of an electrically conductive material,
the pipette nozzle and the pipette calibration probe are coupled by inserting the lower end of the pipette nozzle into the orifice, and
coupling of the pipette nozzle with the pipette calibration probe provides a continuous electrical conductivity path through the pipette nozzle to and through the calibration probe shaft.

9. The pipette calibration probe of claim 8, wherein contact of a lower tip of the calibration probe shaft with a surface at a calibration location provides electrical conductivity from a pipette through the pipette nozzle through the calibration probe shaft and to the surface.

10. The pipette calibration probe of claim 9, wherein electrical conductivity from the pipette through the pipette nozzle through the calibration probe shaft and to the surface provides for capacitive sensing of a point of contact of the lower tip of the calibration probe shaft with the surface.

11. The pipette calibration probe of claim 10, wherein providing for capacitive sensing includes providing an electromagnetic field about the lower tip of the calibration probe shaft enabling sensing of the point of contact when the lower tip of the calibration probe shaft is proximal to the surface.

12. A gripper arm calibration system, comprising:
a gripper arm including a calibration probe orifice defined in a lower end of the gripper arm;
a magnet disposed in an interior of the calibration probe orifice; and
a calibration probe including a calibration probe shaft, the calibration probe shaft including an upper end and a lower end and including a retainer band disposed circumferentially around the calibration probe shaft between the upper end and the lower end,
wherein the upper end and the lower end of the calibration probe shaft are configured to be inserted into the calibration probe orifice until the upper end or the lower end of the calibration probe shaft contacts the magnet to hold the calibration probe shaft in the calibration probe orifice.

13. The gripper arm calibration system of claim 12, wherein:
the calibration probe orifice includes a pathway into the lower end of the gripper arm in longitudinal alignment with the gripper arm, the pathway including a depth corresponding to a length of the calibration probe shaft extending from the upper end or the lower end of the calibration probe shaft to the retainer band; and
the magnet disposed in an interior of the calibration probe orifice being further disposed at an end of the pathway configured to magnetically engage the upper end or the lower end of the calibration probe shaft.

14. The gripper arm calibration system of claim 12, further comprising an electrical contact disposed in an interior of the lower end of the gripper arm, the electrical contact configured to contact with the upper end or the lower end of the calibration probe shaft.

15. The gripper arm calibration system of claim 14, wherein:
the calibration probe shaft is comprised of an electrically conductive material; and
contacting the electrical contact with the upper end or the lower end of the calibration probe shaft provides a continuous electrical conductivity path from the gripper arm through the calibration probe shaft.

16. The gripper arm calibration system of claim 15, wherein contact of a lower tip of the calibration probe shaft with a surface at a calibration location provides electrical conductivity from the gripper arm through the calibration probe shaft and to the surface.

17. The gripper arm calibration system of claim 16, wherein providing a continuous electrical conductivity path from the gripper arm through the calibration probe shaft and to the surface provides for capacitive sensing of a point of contact of the lower tip of the calibration probe shaft with the surface.

18. The gripper arm calibration system of claim 17, wherein providing for capacitive sensing includes providing an electromagnetic field about the lower tip of the calibration probe shaft enabling sensing of the point of contact when the lower tip of the calibration probe shaft is proximal to the surface.

19. A liquid handling system calibration system, comprising:
a liquid handling system including a moveable component for transporting materials or devices to one or more locations on a deck of the liquid handling system; and
a calibration probe affixed to a lower end of the moveable component for calibrating the moveable component, the calibration probe providing electrical conductivity from the moveable component through the calibration probe for providing capacitive sensing of a point of contact of a lower tip of the calibration probe with a surface,
wherein the liquid handling system:
lowers the lower tip of the calibration probe to a point on the surface near an edge of a target calibration slot defined the surface, the target calibration slot including a calibration aperture defined in surrounded by a plurality of edges between the calibration aperture and a surface area around the calibration aperture;
iteratively raises, lowers, and moves the lower tip of the calibration probe until the plurality of edges are located;
determines a geometric center or other specific point in the calibration aperture based on the plurality of edges as located; and
calibrates the moveable component to the geometric center or other specific point in the calibration aperture as determined.

20. The liquid handling system calibration system of claim 19, wherein the moveable component includes at least one of a moveable stage assembly including a pipette and pipette nozzle and a gripper system arm.
